(19) United States
(12) Patent Application Publication
(10) Pub. No.: US 2025/0055315 A1
(43) Pub. Date: Feb. 13, 2025

(54) Energy Harvesting Electronic Devices with Ultra-Low Power Consumption

(71) Applicant: Lightricity Limited, Oxford (GB)

(72) Inventors: Julien Pierre Raymond Campos, Oxford (GB); Mathieu Bellanger, Oxford (GB); Nathan James Smith, Oxford (GB); Matthias Kauer, Oxford (GB)

(21) Appl. No.: 18/721,541

(22) PCT Filed: Dec. 20, 2022
(86) PCT No.: PCT/GB2022/053322

§ 371 Date: Jun. 18, 2024

(30) Foreign Application Priority Data
Dec. 22, 2021 (GB) 2118766.1

(51) Int. Cl. H02J 50/00; H02J 7/35

(52) U.S. Cl. CPC H02J 50/001; H02J 7/35

(57) ABSTRACT

An electronic device comprises a photovoltaic unit, an energy storage unit, a voltage detector, a load switch and an application load. The device is configured to harvest and store energy from ambient illumination, and to optimise power delivery to the application load from at least one of the harvested energy and the stored energy. The photovoltaic unit, the energy storage unit, the voltage detector and an input of the load switch are connected to a common point. The photovoltaic unit harvests energy from the ambient illumination. An output of the load switch is coupled to the application load. The voltage detector measures a voltage at the common point and turns on the load switch when the measured voltage has increased to a level that is greater than or equal to a first voltage, in order to provide optimised power delivery to the application load from at least one of the energy storage unit and photovoltaic unit. The voltage detector turns off the load switch when the measured voltage has decreased to a level that is not greater than a second voltage, in order that the photovoltaic unit stores energy in the energy storage unit, wherein the first voltage is greater than the second voltage.

### TECHNICAL FIELD

This disclosure relates to energy harvesting circuit designs with ultra-low power consumption.

### BACKGROUND OF THE INVENTION

Real-time locating systems (RTLS), also known as real-time tracking systems, are used to automatically identify and track the location of objects or people in real time. Unlike global positioning satellite (GPS) systems, RTLS are usually operated within a building or other contained area. Wireless RTLS tags are attached to physical objects or worn by people. In most RTLS, fixed reference points receive wireless “beacon” signals from tags to determine the location of said tag. RTLS reference points may also transmit information to the tag. The reference points are spaced throughout a building (or similar area of interest) to provide the desired tag coverage. Tag location accuracy is a function of many variables. Examples of real-time locating systems include tracking automobiles through an assembly line, locating pallets of merchandise in a warehouse, or finding medical equipment in a hospital.

RTLS designs that have been previously disclosed use a combination of at least one photovoltaic cell (solar cell) and one battery to power the operation of the tag. If the battery becomes discharged, then the tag (and hence the asset it is attached to) becomes temporarily lost until the battery can be charged sufficiently to enable the tag to send a beacon signal. The battery may become discharged if the circuit is not optimized and/or the ambient lighting levels are too low. A larger battery and/or larger voltaic cell will enable regular beacon signals to be transmitted from the tag but such a design has increased cost, increased maintenance (even rechargeable batteries require replacement over time) and increased dimensions. An ideal tag design would therefore be small, low cost and can harvest energy from the surroundings in order to provide a beacon signal at regular intervals regardless of the energy harvesting conditions.

Wireless RTLS tags have been disclosed that use sensors that communicate information detected by the sensor to fixed reference points. Such sensor tags communicate both the location of the tag and at least one physically detected attribute (such temperature, humidity, acceleration etc.). If the tag is attached to an immoveable object, then the tag may not be required to communicate location information.

Patent applications US20180295466A1 discloses apparatus, systems and articles of manufacture to provide low-power, short-range radio frequency wireless beacons and beacon housings. The tag disclosed by US20180295466A1 uses a battery but does not disclose how to harvest energy from the surroundings to power the tag and does not disclose optimized circuit designs for ultra-low power operation. Patent application US20100013639A1 discloses a system which provides asset tracking of a mobile asset but does not disclose optimized circuit designs for ultra-low power operation. Patent applications US2019/0354824A1, US20180110012A1, US20210073153A1, US20190028089A1, US20110264293A1, US20130020880A1, U.S. Pat. Nos. 8,264,194B1, 8,686,681B2, 10,211,647B2, EP1751727B1, EP3787148A1, US20190265664A1, WO2011083424A1, EP3264785B1 and WO2016187019A1 disclose various tag devices that are used for sensing purposes and/or locating the tag.

### SUMMARY OF THE INVENTION

The present invention seeks to achieve various electronic devices that harvest energy from ambient illumination and store the harvested energy. These electronic devices are configured to optimize power delivery to an associated application load in order to optimize the amount of useful work performed by the harvested energy in the electronic device. Optimizing the amount of useful work performed by the energy harvested lowers overall power consumption of the electronic device. Electronic devices of the present invention may be tag devices or be included within a tag device. The electronic device may communicate information via a wireless transmitter to a network of wireless receivers. The electronic device may communicate information that enables the electronic device's location to be ascertained and/or the electronic device may communicate information related to data acquired by one or more sensors associated with the electronic device. Some aspects of the invention disclose electronic devices that measure the ambient illuminance level and automatically optimize power delivery to the associated application load accordingly. If the electronic device includes a wireless transmitter, optimized power delivery may enable an optimized transmission rate of data by the wireless transmitter (i.e., the electronic device has optimized circuit efficiency). Optimized power delivery to the application load enables optimized circuit efficiency, which in turn results in the application load optimizing the amount of useful work performed for the energy harvested by the electronic device.

Aspects of the present invention seek to optimize power delivery to an application load within an electronic device in order to achieve lower overall power consumption than conventional art, thus enabling an electronic device of reduced size and lower cost while maintaining acceptable circuit efficiency. In other words, for the same amount of energy, electronic devices of the present invention seek to perform more useful work and have higher circuit efficiency than electronic devices of conventional art, thus enabling the advantages of lower cost and reduced size. The optimized power delivery of electronic devices pertaining to the present invention have higher circuit efficiency for a greater range of ambient illumination conditions than conventional art. In other words, electronic devices of the present invention may operate in lower ambient illumination conditions than convention art. The optimized power delivery of electronic devices pertaining to the present invention enable acceptable operation for the vast majority of ambient illumination conditions. Aspects of the present invention utilize smaller photovoltaic units than conventional art thus enabling reduced size, lower cost while maintaining acceptable circuit efficiency. Unlike conventional art, some electronic devices pertaining to the present invention do not utilize a battery or rechargeable battery (i.e., only capacitors and/or supercapacitors are used to store energy), thus enabling a further reduction in size and cost while maintaining an acceptable circuit efficiency.

An aspect of the present invention provides an electronic device comprising a photovoltaic unit, an energy storage unit, a voltage detector, a load switch and an application load, wherein the electronic device is configured to:
harvest and store energy from ambient illumination; and
optimize power delivery to the application load from at least one of the harvested energy and the stored energy,
wherein:
the photovoltaic unit, the energy storage unit, the voltage detector and an input of the load switch are connected to a common point;
the photovoltaic unit is configured to harvest energy from the ambient illumination;
an output of the load switch is coupled to the application load;
the voltage detector is configured to measure a voltage at the common point;
the voltage detector is further configured to turn on the load switch when a voltage measured at the common point has increased to a level that is greater than or equal to a first voltage in order to provide optimized power delivery to the application load from at least one of the energy storage unit and photovoltaic unit;
the voltage detector is further configured to turn off the load switch when a voltage measured at the common point has decreased to a level that is not greater than a second voltage in order that the photovoltaic unit stores energy in the energy storage unit; and
the first voltage is greater than the second voltage.

An electronic device of the present invention may be configured so that the application load performs a boot-up sequence followed by at least one activity sequence when the load switch is turned on.

An electronic device of the present invention may be configured to complete an activity sequence that has been started.

An electronic device of the present invention may be configured so that the first voltage is within 20% of the voltage produced by the photovoltaic unit at the maximum power point of the photovoltaic unit for a given temperature.

An electronic device of the present invention may be configured so that the energy storage unit comprises at least one of a battery and a rechargeable battery.

An electronic device of the present invention may be configured so that the energy storage unit comprises at least one of a capacitor and a supercapacitor.

An electronic device of the present invention may comprise a voltage regulator connected between the load switch and the application load.

An electronic device of the present invention may comprise at least one sensor associated with the application load and configured to collect data related to at least one of: orientation, acceleration, temperature, humidity, air pressure, light, lux, magnetic field, sound, infra-red radiation, ultra-violet radiation, gas, proximity, images, and a user input or any combination thereof.

An electronic device of the present invention may be configured so that data collected by a sensor is stored in a memory associated with the application load.

An electronic device of the present invention may comprise at least one actuator associated with the application load and configured to collect data related to at least one of: a push button, a switch, touch sensor and a user input or any combination thereof.

An electronic device of the present invention may be configured so that the data collected by an actuator is stored in a memory associated with the application load.

An electronic device of the present invention may be configured so that at least one of a sensor and an actuator initiates an activity sequence.

An electronic device of the present invention may comprise a lux sensor associated with the application load, wherein:
the application load and the associated lux sensor are configured to measure an ambient lux level; and
the application load and the associated lux sensor are further configured to automatically optimize circuit efficiency according to the measured level of ambient lux.

An electronic device of the present invention may be configured so that:
the photovoltaic unit has a direct connection to the application load;
the photovoltaic unit and application load are configured to measure an ambient lux level; and
the photovoltaic unit and application load are further configured to automatically optimize circuit efficiency according to the measured level of ambient lux.

An electronic device of the present invention may be configured so that the application load comprises a wireless communication unit.

An electronic device of the present invention may be configured so that the wireless communication unit is a Bluetooth Low Energy transmitter.

An electronic device of the present invention may be configured so that the application load performs a boot-up sequence followed by an activity sequence when the load switch is turned on, wherein the activity sequence includes transmitting information to a network of wireless receivers.

An electronic device of the present invention may be configured so that the transmitted information includes at least one of: a beacon signal; data collected from at least one sensor associated with the application load; data collected from at least one sensor that has been stored in a memory associated with the application load, data collected from at least one actuator associated with the application load, data collected from at least one actuator that has been stored in a memory associated with the application load and a measured level of ambient lux; or any combination thereof.

An electronic device of the present invention may be configured so that the application load comprises a control unit connected to a core activity function load.

An electronic device of the present invention may be arranged so that the control unit and the core activity function load are configured to exchange information.

An electronic device of the present invention may be configured so that the control unit comprises at least one of: a field-programmable gate array (FPGA); a microcontroller; and a logic unit; or any combination thereof.

An electronic device of the present invention may be configured so that:
the further voltage detector and an output of the load switch are connected at a further common point; and
the further voltage detector is configured to measure a voltage at the further common point.

An electronic device of the present invention may be configured so that:
the further voltage detector and the application load are configured to perform an activity sequence when a voltage measured at the further common point has increased to a level that is greater than or equal to a third voltage;
the further voltage detector and the application load are further configured to stop performing further activity sequences when a voltage measured at the further common point has decreased to a level that is not greater than a fourth voltage;
the third voltage is greater than the second voltage;
the fourth voltage is greater than the second voltage; and
the third voltage is greater than the fourth voltage.

An electronic device of the present invention may comprise a timer connected to the application load.

An electronic device of the present invention may be arranged so that timer and the application load are configured to start a countdown sequence on the timer during the boot-up sequence.

An electronic device of the present invention may be arranged so that the timer and the application load are configured to start a countdown sequence on the timer during the activity sequence.

An electronic device of the present invention may be arranged so that the timer and the application load are configured to perform at least one activity sequence when all the following conditions are satisfied:
the countdown sequence on the timer has finished;
the further voltage detector measures a voltage at the further common point that is less than the third voltage; and
the voltage detector measures a voltage at the common point that is greater than the second voltage.

An electronic device of the present invention may have an associated method to optimize power delivery to an application load, wherein the electronic device comprises: a photovoltaic unit, an energy storage unit, a voltage detector, a load switch and an application load, wherein the application load has a boot-up sequence and an activity sequence;
the method comprising:
charging the energy storage unit from the photovoltaic unit while the load switch is turned off;
turning on the load switch in response to detecting a voltage on the voltage detector that is greater than or equal to a first voltage;
after turning on the load switch, performing the boot-up sequence;
after the boot-up sequence, performing at least one activity sequence;
stopping performing activity sequences, and turning off the load switch, in response to detecting a voltage on the voltage detector that is not greater than a second voltage; and
the first voltage is greater than the second voltage.

An electronic device of the present invention as previously disclosed comprises a further voltage detector, the method further comprising:
after the boot-up sequence, entering an idle mode in response to: i) detecting a voltage on the further voltage detector that is less than a third voltage and ii) detecting a voltage on the voltage detector that is greater than the second voltage;
exiting the idle mode and performing an activity sequence in response to detecting a voltage on the further voltage detector that is greater than or equal to the third voltage;
performing at least one further activity sequence in response to detecting a voltage on the further voltage detector that is greater than a fourth voltage;
stopping performing activity sequences, and entering the idle mode, in response to: i) detecting a voltage on the further voltage detector that is not greater than the fourth voltage and ii) detecting a voltage on the voltage detector that is greater than the second voltage; and
exiting the idle mode and turning off the load switch in response to detecting a voltage on the voltage detector that is not greater than the second voltage;
the third voltage is greater than the second voltage;
the fourth voltage is greater than the second voltage; and
the third voltage is greater than the fourth voltage.

An electronic device of the present invention as previously disclosed comprises a further voltage detector and a timer, the method further comprising:
after performing the boot-up sequence, starting a countdown on the timer;
after starting the countdown on the timer, entering an idle mode in response to: i) detecting a voltage on the further voltage detector that is less than a third voltage, and; ii) the countdown on the timer not having finished, and iii) detecting a voltage on the voltage detector that is greater than the second voltage;
exiting the idle mode and performing an activity sequence in response to either: i) detecting a voltage on the further voltage detector that is greater than or equal to the third voltage; or ii) the countdown on the timer finishing;
during the activity sequence, re-starting the countdown on the timer;
performing at least one further activity sequence in response to detecting a voltage on the further voltage detector that is greater than a fourth voltage;
stopping performing the activity sequences, and entering the idle mode, in response to: i) detecting a voltage on the further voltage detector that is not greater than the fourth voltage and ii) detecting a voltage on the voltage detector that is greater than the second voltage; and
exiting the idle mode and turning off the load switch in response to detecting a voltage on the voltage detector that is not greater than the second voltage;
the third voltage is greater than the second voltage;
the fourth voltage is greater than the second voltage; and
the third voltage is greater than the fourth voltage.

An electronic device may comprise a photovoltaic unit, an energy storage unit, a voltage detector, a load switch and an application load, wherein the application load has a boot-up sequence and an activity sequence, and wherein the electronic device is configured to perform any of the methods previously disclosed.

### BRIEF DESCRIPTION OF THE DRAWINGS

Certain preferred embodiments of the invention will now be described, by way of example only, with reference to the accompanying drawings, in which:

FIG. 1 is a plot showing the 3 different ambient lux ranges;

FIG. 2 is a block diagram of a first example electronic device;

FIG. 3 is a flow diagram of operation for a first example electronic device;

FIG. 4 is a table showing example application loads and example activity sequences;

FIG. 5 is a plot showing operation for a first example electronic device;

FIG. 6 is a block diagram of a second example electronic device;

FIG. 7 is a flow diagram of operation for a second example electronic device;

FIG. 8 is a plot showing operation for a second example electronic device;

FIG. 9 is a table showing various relationships of various voltages;

FIG. 10 is a block diagram of a third example electronic device;

FIG. 11 is a flow diagram of operation for a third example electronic device;

FIG. 12a is a plot showing operation for a third example electronic device;

FIG. 12b is a further plot showing operation for a third example electronic device;

FIG. 13 is a plot showing the relative efficiency of 3 example electronic devices;

FIG. 14 is a table showing the relative merits of 3 example electronic devices;

FIG. 15 is a block diagram of a first example electronic device with an example application load;

FIG. 16 is a block diagram of a second example electronic device an example application load;

FIG. 17 is a block diagram of a third example electronic device with an example application load;

FIG. 18a is a block diagram of a fourth example electronic device;

FIG. 18b is a block diagram of a further fourth example electronic device;

FIG. 19a is a block diagram of a fifth example electronic device;

FIG. 19b is a block diagram of a further fifth example electronic device;

FIG. 20 is a block diagram of a sixth example electronic device;

FIG. 21 is a block diagram of a seventh example electronic device,

### DETAILED DESCRIPTION

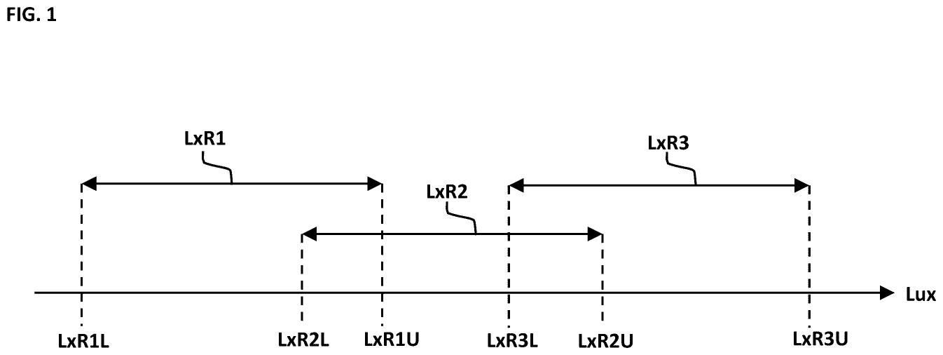

FIG. 1 shows a plot of 3 different ambient lux ranges (i.e., 3 different ambient illumination ranges). LxR1 represents a first range of ambient lux values, with a lower lux value of LxR1L and an upper lux value of LXR1U. LxR2 represents a second range of ambient lux values, with a lower lux value of LxR2L and an upper lux value of LXR2U. LxR3 represents a third range of ambient lux values, with a lower lux value of LxR3L and an upper lux value of LXR3U. The ranges LxR1 and LxR2 may partially overlap. The ranges LxR2 and LxR3 may partially overlap. The ranges of LxR1 and LxR3 do not overlap. The following conditions are also respected: LxR1L<LxR2L<LxR3L and LxR1U<LxR2U<LxR3U. For illustrative discussion purposes below, LxR1 represents a range of low ambient lux values that may be below ˜200 lux. LxR1 may represent the lux level measured in a corridor, storage room, warehouse, stairwell, elevator etc. For illustrative discussion purposes below, LxR2 represents a range of medium ambient lux values that may be in the range ˜200 lux to ˜500 lux. LxR2 may represent the lux level measured in a classroom, a conference room, office etc. For illustrative discussion purposes below, LxR3 represents a range of high ambient lux values that may be above ˜500 lux. LxR3 may represent the lux level measured in a kitchen, laboratory, workshop, supermarket etc. LxR3 may represent the lux level measured in any room designated for medical procedures, such as a surgical theatre etc. The low, medium and high ambient lux ranges may include illumination from man-made light sources (for example, LEDs, fluorescent lights etc.) or from natural light sources (for example, the sun) or any combination thereof.

Various ultra-low power electronic devices are disclosed within this disclosure. Circuit efficiency is a metric that can be used to compare the performance of these various ultra-low power electronic devices. For the purposes of this disclosure, circuit efficiency has been defined as being proportional to the average repetition rate of an activity sequence for a given constant level of illumination. If the activity sequence includes transmitting information to a wireless network, then the average repetition rate of an activity sequence must not exceed the maximum value dictated by standardized protocols. For example, 10 Hz is the maximum repetition rate for a non-connected (i.e., wireless) beacon signal.

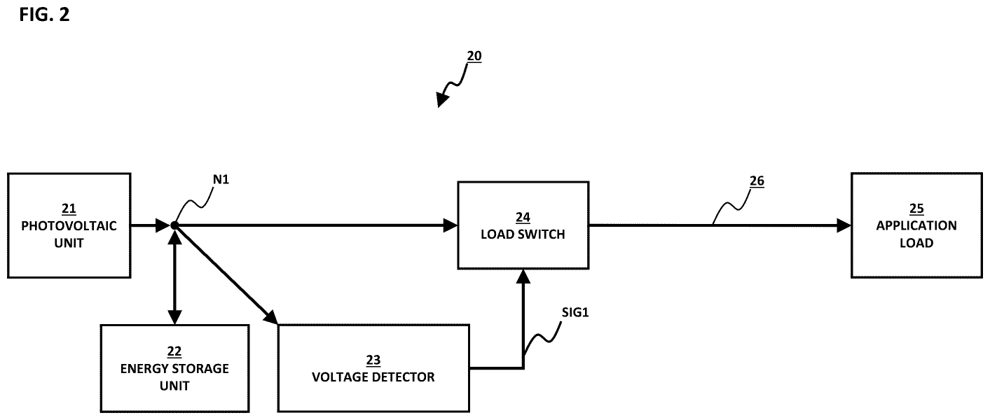

FIG. 2 is a block diagram of a first example electronic device 20 that includes a photovoltaic unit 21, an energy storage unit 22, a voltage detector 23, a load switch 24 and an application load 25. The voltage detector 23 is connected to N1 (node 1) and detects the voltage at N1 (node 1). Node 1 is a common point. The voltage detector 23 is also connected to the load switch 24 via SIG1 (signal 1). Power line 26 provides power to all units included within the application load 25. Power line 26 provides power to all units associated with the application load 25. The application load 25 may use power provided by power line 26 to power any units (such as sensors, actuators etc.) that are associated with the application load 25. The photovoltaic unit 21 is connected to N1. The energy storage unit 22 is connected to N1. An input of the load switch 24 is connected to N1. The photovoltaic unit 21, the energy storage unit 22 and the voltage detector 23 are connected to an input of the load switch 24. In general, an output of the load switch 24 is coupled to the application load 25 via power line 26.

The photovoltaic unit 21 may include at least one photovoltaic cell. The photovoltaic unit 21 may be of general construction but is preferably optimized for optical spectra produced by indoor lighting conditions if the electronic device is primarily situated indoors. The photovoltaic unit 21 may produce a maximum power of 10 μW at 200 lux. The photovoltaic unit 21 may produce a maximum power of 5 μW at 200 lux. The photovoltaic unit 21 may produce a maximum power of 2 μW at 200 lux.

The energy storage unit 22 may include at least 1 battery and/or 1 rechargeable battery and/or at least 1 capacitor and/or at least 1 super capacitor. For the electronic device to have lower power consumption, reduced size and lower cost, it may be preferable that the energy storage unit 22 is comprised solely of capacitors. If the energy storage unit 22 is comprised solely of capacitors then the total capacitance may by less than 500 μF and preferably less than 250 μF. The photovoltaic unit 21 harvests energy from the ambient illumination and stores this energy in the energy storage unit 22.

The voltage detector 23 is configured to turn on the load switch 24 for voltages greater than a first voltage. The first voltage may be V1A. The voltage detector 23 is further configured to turn off the load switch 24 for voltages less than or equal to a second voltage wherein the first voltage is greater than the second voltage. The second voltage may be V1B. The voltage detector 23 may have a hysteresis of less than 600 mV. The voltage detector 23 may have a hysteresis of less than 400 mV. The voltage detector 23 may have a hysteresis of less than 200 mV. The load switch 24 may be an integrated load switch.

The application load 25 may include at least one control unit. The control unit may include at least one field-programmable gate array (FPGA) and/or at least one microcontroller and/or at least one logic unit. The application load 25 may include a wireless communication unit (not shown) which may be a Bluetooth Low Energy (BLE) wireless communication unit. The application load 25 may be associated with at least one sensor and/or one actuator. The application load 25 may be associated with at least one sensor and/or actuator that is within the application load (i.e., an internal sensor and/or actuator that is not shown in FIG. 2) and/or the application load 25 may be associated with at least one sensor and/or actuator that is located outside of the application load 25 but is connected to the application load 25 (i.e., an external sensor and/or actuator that is not shown in FIG. 2). All sensors associated with the application load 25 (i.e., internal sensors and external sensors) may collect data related to at least one of the following items: orientation, acceleration, temperature, humidity, air pressure, light (illuminance, lux), magnetic field, sound, infra-red radiation, ultra-violet radiation, gas (such as CO, CO2, methane etc.), proximity, images (i.e., a camera) and a user input. All actuators associated with the application load 25 (i.e., internal actuators and external actuators) may collect data related to at least one of the following items: push button, a switch, touch sensor and a user input.

In general, a sensor and/or actuator associated with the application load 25 may be configured to receive an input from a user. For example, the actuator may be a button configured to detect a press performed by a user. For example, the actuator may be a switch configured to detect the current switch state and a change to the switch state performed by a user. The sensor may be a microphone configured to detect sound from the environment and/or from a user.

The application load 25 may provide power to at least one sensor and/or actuator. When the load switch 24 is turned on, the first example electronic device 20 is configured such that the application load 25 performs a complete boot-up sequence followed by at least one complete activity sequence. The maximum current drawn by the application load 25 during the boot-up sequence may be less than 50 mA and is preferably less than 1 mA. The maximum energy consumed by the application load 25 in order to complete the boot-up sequence may be less than 100 μJ and is preferably less than 10 μJ. The maximum current drawn by the application load 25 during the activity sequence may be less than 50 mA and is preferably less than 1 mA. The maximum energy consumed by the application load 25 in order to complete a single activity sequence may be less than 50 μJ and is preferably less than 20 μJ.

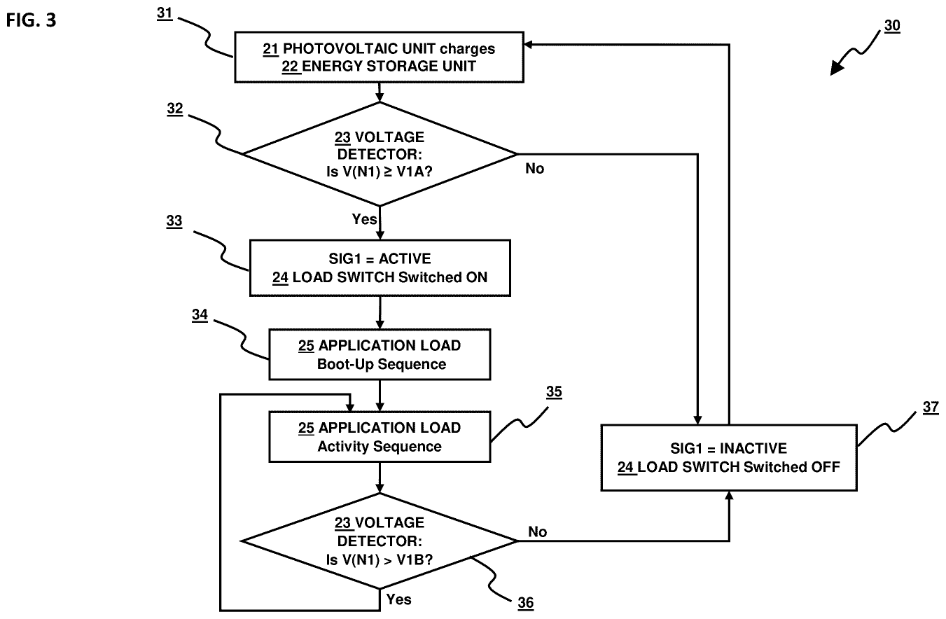

FIG. 3 is a flow diagram 30 illustrating the operation of the first example electronic device 20 shown in FIG. 2. Flow diagram item 31 shows the photovoltaic unit 21 producing electrical charge that is stored in the energy storage unit 22 (i.e., energy generated by the photovoltaic unit 21 is stored in the energy storage unit 22). Flow diagram item 32 shows the voltage detector 23 measuring the voltage at node 1. The voltage at node 1 is given by V(N1). If V(N1)≥V1A then the voltage detector 23 sends an activate signal (SIG1=ACTIVE) to the load switch 24 which turns the load switch 24 ON as shown in flow diagram items 32 and 33. The predetermined voltage V1A may be in the range from VMP±20% and preferably in the range from VMP±10% where VMP is the voltage at maximum power point of the photovoltaic unit 21. If V(N1) [symbol] V1A (i.e., V(N1)<V1A) then the voltage detector 23 sends a deactivate signal (SIG1=INACTIVE) to the load switch 24 which turns the load switch 24 OFF as shown in flow diagram item 32 and 37. If the load switch 24 is in the OFF state (SIG1=INACTIVE), the photovoltaic unit 21 continues to produce electrical charge that is stored in the energy storage unit 22. While the load switch 24 remains in the ON state, the application load 25 receives sufficient energy from the energy storage unit 22 and/or the photovoltaic unit 21 to perform a boot-up sequence and at least 1 activity sequence, as shown by flow diagram item 34 and 35. In general, when the load switch 24 is turned on, example electronic devices described herein are configured to perform a boot-up sequence to completion and perform at least 1 activity sequence to completion, which may contribute to the optimization of useful work performed by the harvested energy. If an example electronic device described herein fails to complete a boot-up sequence owning to a lack of harvested energy, then the amount of useful work performed by the electronic device has not been optimized. If an example electronic device described herein fails to complete a started activity sequence owning to a lack of harvested energy, then the amount of useful work performed by the electronic device has not been optimized. If an example electronic device described herein completes a boot-up sequence but does not complete at least one activity sequence owning to a lack of harvested energy, then the amount of useful work performed by the electronic device has not been optimized. The boot-up sequence may involve loading a program into volatile memory within a control unit (not shown in FIG. 2). The boot-up sequence may involve a clock stabilization process. Flow diagram item 35 shows the application load 25 performing a predetermined activity sequence which may include transmitting information via a wireless communication unit to at least one further device (not shown). If the activity sequence includes transmitting information via a Bluetooth Low Energy unit, then a timer sequence may be configured within the activity sequence to ensure a Bluetooth protocol related to transmission repetition rate is not violated. If V(N1)>V1B, then a further activity sequence is performed, as shown by flow diagram items 35 and 36. In order to contribute to the optimization of useful work performed by the harvested energy, if V(N1)>V1B then the first example electronic device 20 is configured to perform and complete at least 1 further activity sequence. In general, an example electronic device described herein is configured so that an activity sequence is only started if the example electronic device has enough energy to complete the activity sequence. If V(N1)≯V1B (i.e., V(N1) is not greater than V1B), then the voltage detector 23 sends a deactivate signal (SIG1=INACTIVE) to the load switch 24 which turns the load switch 24 OFF as shown in flow diagram items 36 and 37. Whenever SIG1=INACTIVE, the photovoltaic unit 21 produces electrical charge that is stored in the energy storage unit 22, as shown by flow diagram item 31. Flow diagram item 37 may be considered the start of the flow diagram 30.

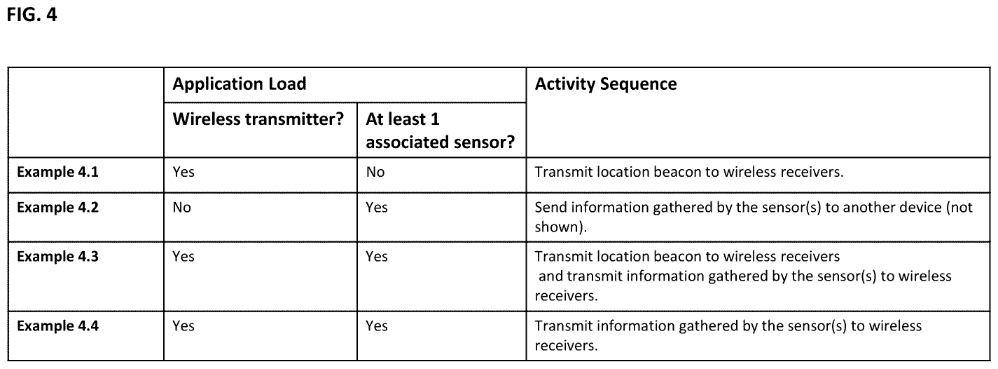

FIG. 4 shows 4 examples (example 4.1 through 4.4) of an application load with an associated activity sequence. Examples 4.1 through 4.4 may be used in conjunction with any electronic device disclosed herein. The application load in example 4.1 includes a wireless transmitter. The activity sequence in example 4.1 includes transmitting a location beacon to wireless receivers (not shown within this disclosure) via a wireless communication unit (not shown within this disclosure). The application load in example 4.2 includes at least 1 associated sensor (i.e., an internal sensor or an external sensor). The activity sequence in example 4.2 includes sending information gathered by the sensor(s) to another device (not shown within this disclosure). The application load in example 4.3 includes a wireless transmitter and at least 1 associated sensor. The activity sequence in example 4.3 includes transmitting a location beacon to wireless receivers (not shown within this disclosure) and transmitting information gathered by the associated sensor(s) to wireless receivers (not shown within this disclosure). The application load in example 4.4 includes a wireless transmitter and at least 1 associated sensor. The activity sequence in example 4.4 includes transmitting information gathered by the associated sensor(s) to wireless receivers (not shown within this disclosure). The transmitted information gathered by associated sensor(s) may also be used as a location beacon. Using the transmission of information gathered by associated sensor(s) to also provide electronic device location information may further reduce power consumption of any electronic device disclosed herein since the amount of transmitted data may be minimized. Therefore, the activity sequence in example 4.4 may consume less power than the activity sequence in example 4.3 while the functionality of example 4.3 and example 4.4 may be the same.

A first advantage of the first example electronic device 20 is the capability to operate correctly (i.e., perform at least 1 activity sequence) in low ambient lux levels (i.e., in low levels of ambient light illumination). In other words, the first example electronic device has good circuit efficiency in low ambient lux levels. With reference to FIG. 1, the first example electronic device 20 has the capability to operate in the first lux range LxR1 where LxR1U is 200 Lux and preferably the first example electronic device 20 has the capability to operate correctly where LxR1L is 20 Lux. The first example electronic device 20 also has the capability to operate correctly at all ambient lux values above LxR1L and therefore the first example electronic device 20 can operate correctly within the lux ranges of LxR1, LxR2 and LxR3. A second advantage of the first example electronic device 20 is the relatively low number of components required and therefore the first example electronic device 20 has lower cost and lower weight compared with other example electronic device designs disclosed below.

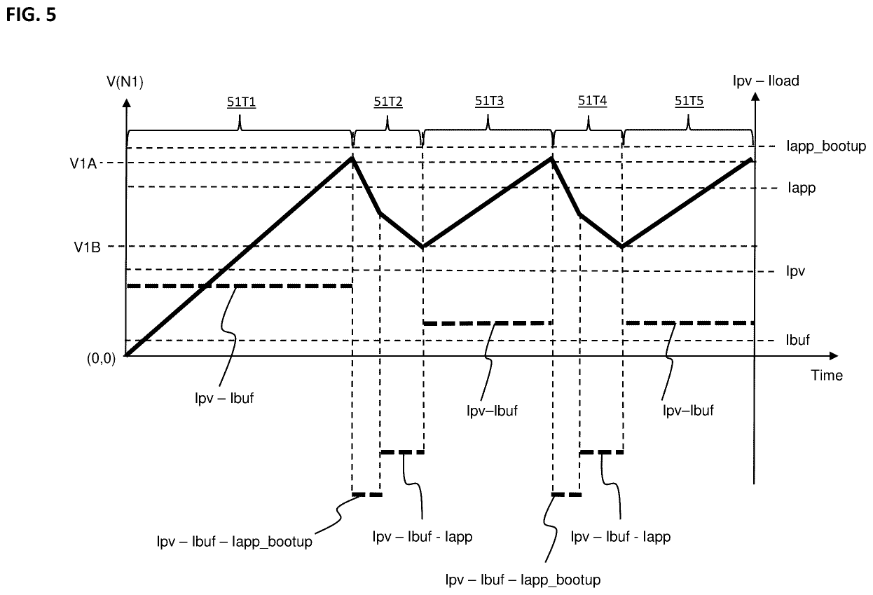

FIG. 5 is a plot illustrating the operation of a first example electronic device 20 for a constant level of ambient illumination. The constant level of illumination may be in the range LxR2. With reference to FIG. 5, Ipv is the current produced by the photovoltaic unit 21. With reference to FIG. 5, Ibuf is the current drawn by the voltage detector 23 plus the current drawn by the load switch 24. With reference to FIG. 5, Iapp is the current drawn by the application load 25. With reference to FIG. 5, Iload is the total current drawn by all loads in the first example electronic device 20. The left-hand side ordinate shows how the voltage at node 1, V(N1), varies with respect to time (solid line). The right-hand side ordinate shows how the quantity Ipv−Iload varies as a function of time (heavy dashed line). Various values (such as V1A, V1B etc.) are shown with light dashed lines. When the quantity Ipv−load is greater than 0 then the energy generated by photovoltaic unit 21 is greater than the energy consumed by all loads within the first example electronic device 20 (i.e., the electronic device 20 generates more energy than it consumes). When the quantity Ipv−Iload is less than 0 then the energy generated by photovoltaic unit 21 is less than the energy consumed by all loads within the electronic device 20 (i.e., the electronic device 20 generates less energy than it consumes). When V(N1)≯V1B (i.e., V(N1) is not greater than V1B), the load switch 24 is always switched OFF and the energy generated by the photovoltaic unit 21 is stored in the energy storage unit 22. At the start of time interval 51T1 (i.e., time=0), the energy storage unit 22 has no stored energy. During the time interval 51T1, the load switch 24 is switched OFF. During the time interval 51T1, Ipv−Ibuf>0 and therefore V(N1) increases with time from 0 to V1A. Since the ambient illumination is constant, the value Ipv−Iload is constant and equal to Ipv−Ibuff. At the start of time period 51T2, V(N1)≥V1A, therefore voltage detector 23 turns on the load switch 24 (SIG1=ACTIVE) enabling the application load 25 to consume energy from the photovoltaic unit 21 and/or the energy storage unit 22. Consequently, during the time period 51T2, the application load 25 firstly performs a boot-up sequence (i.e., Ipv−Iload=Ipv−Ibuf−Iapp_bootup) and secondly performs at least 1 activity sequence (i.e., Ipv−Iload=Ipv−Ibuf−Iapp). As shown in the time period 51T2, the power consumption of the boot-up sequence is, in general, greater than the power consumption of the activity sequence. Thus, the time period 51T2 shows V(N1) decreasing with respect to time more quickly during the boot-up sequence than the activity sequence. The linear variations of V(N1) with respect to time is for illustrative purposes only and may not reflect the complexity of the power consumption. Firstly, during time period 51T2, the value Ipv−Iload is equal to Ipv−Ibuf−Iapp_bootup, and secondly, the quantity Ipv−Iload is equal to Ipv−Ibuf−Iapp. The values of Ipv−Ibuf−Iapp_bootup and Ipv−Ibuf−Iapp are negative during time period 51T2 because the energy consumed by the electronic device 20 is greater than the energy generated by the electronic device 20. While the value of Ipv−Iload is equal to Ipv−Ibuf−Iapp, at least 1 activity sequence is performed. At the start of time interval 51T3, V(N1)≯V1B therefore voltage detector 23 turns off the load switch 24 (SIG1=INACTIVE). During the time interval 51T3, Ipv−Ibuf>0 and therefore V(N1) increases with time. Since the ambient illumination is constant, the value Ipv−Iload is constant and equal to Ipv−Ibuff. Time period 51T4 shows identical operation to the previously described time period 51T2. Time period 51T5 shows identical operation to the previously described time period 51T3.

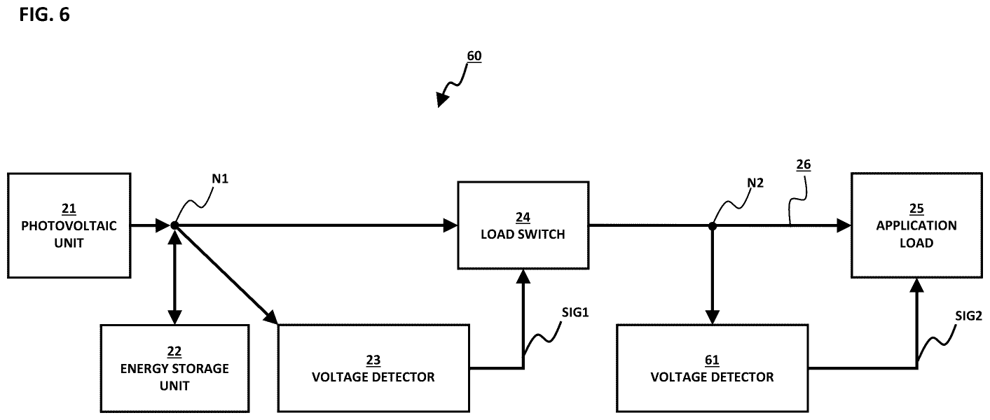

FIG. 6 is a block diagram of a second example electronic device 60. The second example electronic device 60 may be identical to the first example electronic device 20 except that the second example electronic device 60 has a further voltage detector 61. Voltage detector 61 is connected to N2 (node 2) and detects the voltage at N2. Node 2 is a further common point. Node 2 may be considered to be an output of the load switch 24. Voltage detector 61 is also connected to the application load 25 via SIG2 (signal 2). The further voltage detector 61 is configured to activate (i.e., perform) at least one activity sequence (SIG2=ACTIVE) for voltages greater than or equal to a third voltage. In general, for example electronic devices disclosed herein, whenever an activity sequence is “activated”, the electronic device has been configured to have enough energy to perform an activity sequence to completion. In other words, whenever an activity sequence is “activated”, the electronic device has been configured to perform a positive integer number of activity sequences. Completing a positive integer number of activity sequences contributes to the optimization of useful work performed by the harvested energy. The further voltage detector 61 is configured to deactivate the activity sequence for voltages not greater than a fourth voltage. The third voltage may be greater than the fourth voltage. In general, for example electronic devices disclosed herein, when the activity sequence is “deactivated”, a further activity sequence is not performed until a sufficient quantity of energy has subsequently been harvested. In general, for example electronic devices disclosed herein, “deactivating” an activity sequence does not prevent the completion of an activity sequence that has already started. Configuring example electronic devices disclosed herein to complete all started activity sequences may contribute to the optimization of useful work performed by the harvested energy. In other words, completing a positive integer number of activity sequences may contribute to the optimization of useful work performed by the harvested energy.

The voltage detector 61 may have a hysteresis of less than 600 mV. The voltage detector 61 may have a hysteresis of less than 400 mV. The voltage detector 61 may have a hysteresis of less than 200 mV. The voltage detector 61 may be identical to voltage detector 23.

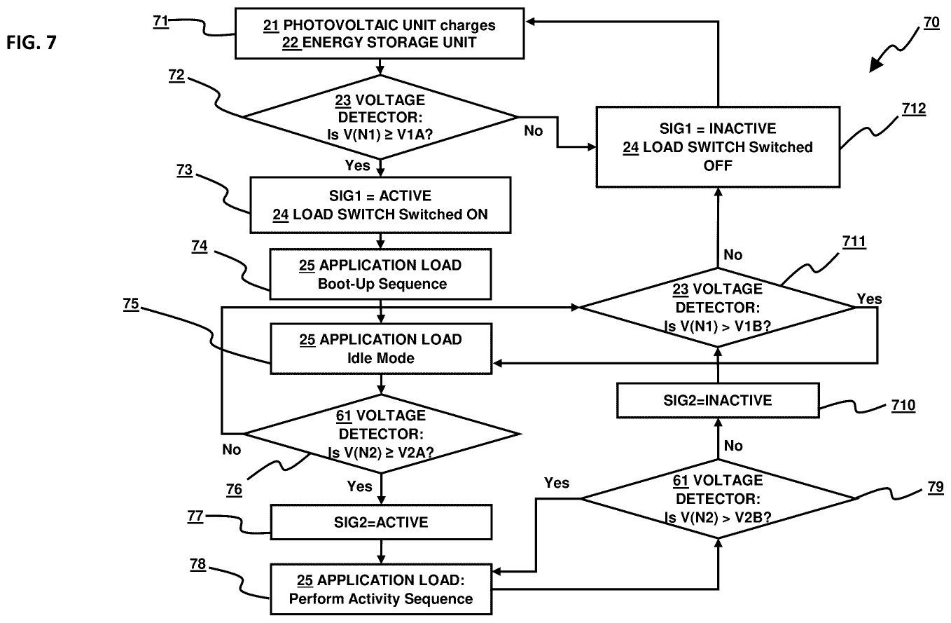

FIG. 7 is a flow diagram 70 illustrating the operation of the second example electronic device 60 shown in FIG. 6. Flow diagram item 71 shows the photovoltaic unit 21 producing electrical charge that is stored in the energy storage unit 22 (i.e., energy generated by the photovoltaic unit 21 is stored in the energy storage unit 22). Flow diagram item 72 shows the voltage detector 23 measuring the voltage at node 1. The voltage at node 1 is given by V(N1). If V(N1)≥V1A then the voltage detector 23 sends a signal (SIG1=ACTIVE) to the load switch 24 which turns the load switch ON as shown in flow diagram item 73. The first predetermined voltage V1A may be in the range from VMP+20% and preferably in the range from VMP+10% where VMP is the voltage at the maximum power point of the photovoltaic unit 21. If V(N1) [symbol] V1A (i.e., V(N1)<V1A) then the voltage detector 23 sends a deactivate signal (SIG1=INACTIVE) to the load switch 24 which turns the load switch 24 OFF as shown in flow diagram item 72 and 712. If the load switch 24 remains in the OFF state, the photovoltaic unit 21 continues to produce electrical charge that is stored in the energy storage unit 22. While the load switch 24 remains in the ON state, the application load 25 receives sufficient energy from the energy storage unit 22 and/or the photovoltaic unit 21 to perform a boot-up sequence, as shown by flow diagram item 74. The boot-up sequence may involve loading a program into volatile memory within a control unit (not shown in FIG. 6). The boot-up sequence may involve a clock stabilization process. Flow diagram item 75 shows the application load 25 entering an idle mode. The purpose of the idle mode is to minimize the number of times the bootup sequence is performed which in turn may contribute to the optimization of useful work performed by the harvested energy. Moving from the idle mode to an activity sequence does not require a further boot-up sequence. Flow diagram item 76 shows the voltage detector 61 measuring the voltage at node 2. The voltage at node 2 is given by V(N2). If V(N2)≥V2A then the voltage detector 61 sends a signal (SIG2=ACTIVE), to the application load 25 so that the application load performs an activity sequence, as shown by flow diagram items 76, 77 and 78 respectively. The predetermined activity sequence shown by flow diagram item 78 may include any of the example activity sequences shown in FIG. 4. The predetermined activity sequence shown by flow diagram item 78 may include transmitting information via a wireless communication unit to at least one further device (not shown). If the activity sequence includes transmitting information via a Bluetooth Low Energy unit, then a timer sequence may be configured within the activity sequence to ensure a Bluetooth protocol related to transmission repetition rate is not violated. The activity sequence may include any of the examples shown in FIG. 4. If V (N2) [symbol] V2A (i.e., V(N2)<V2A) and V(N1)>V1B, then the application load 25 remains in the idle mode, as illustrated by the loop in flow diagram 70 by the flow diagram items 75, 76 and 711. After the application load 25 has performed the activity sequence shown by flow diagram item 78, another activity sequence is performed by the application load 25 if V(N2)>V2B as shown by the flow diagram item 79. If V(N2)≯V2B (i.e., V(N2) is not greater than V2B) then voltage detector 61 sends a signal to the application load 24 (SIG2=INACTIVE) so that the application load stops performing further activity sequences as shown by the flow diagram items 79 and 710. If V(N1)>V1B as shown in flow diagram item 711 then the application load 24 enters the idle mode as shown by flow diagram item 75. If V (N1)≯V1B as shown in flow diagram item 711 then voltage detector 23 sends a signal to turn off the load switch 24 (SIG1=INACTIVE) as shown in flow diagram item 712. When load switch 24 is turned off, the photovoltaic unit 21 produces electrical charge that is stored in the energy storage unit 22 as shown by flow diagram item 71. Flow diagram item 712 may be considered the start of the flow diagram 70.

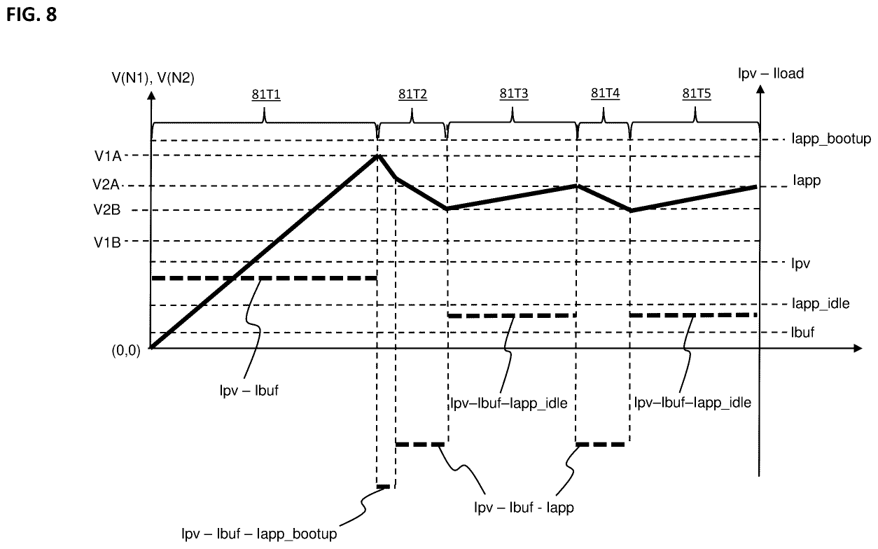

FIG. 8 is a plot illustrating the operation of a second example electronic device 60 for a constant level of ambient illumination. The constant level of illumination may be in the range LxR2. With reference to FIG. 8, Ipv is the current produced by the photovoltaic unit 21. Ibuf is the current drawn by the voltage detector 23 plus the current drawn by the load switch 24. Iapp is the current drawn by the activity sequence of the application load 25. Iload is the total current drawn by all loads in the second example electronic device 60. Iapp_idle is the current drawn when the application load 25 is in the idle mode. Iapp_bootup is the current drawn when the application load 25 performs the boot-up sequence. The current drawn by the voltage detector 61 has been neglected for simplicity since it is always small compared with the various currents drawn by the application load 25. The left-hand side ordinate shows how the voltage at node 1, V(N1), varies with respect to time (solid line) during time period 81T1. The left-hand side ordinate shows how the voltage at node 2, V(N2), varies with respect to time (solid line) during time periods 81T2, 81T3, 81T4 and 81T5. The right-hand side ordinate shows how the quantity Ipv−Iload varies as a function of time (heavy dashed line). Various values (such as V1A, V1B etc.) are shown with light dashed lines. When the quantity Ipv−Iload is greater than 0 then the energy generated by photovoltaic unit 21 is greater than the energy consumed by all loads within the second example electronic device 60 (i.e., electronic device 60 generates more energy than it consumes). When the quantity Ipv−Iload is less than 0 then the energy generated by photovoltaic unit 21 is less than the energy consumed by all loads within the electronic device 60 (i.e., the electronic device 60 generates less energy than it consumes). When V(N1) is not greater than V1B, the load switch 24 is always switched OFF and the energy generated by the photovoltaic unit 21 is stored in the energy storage unit 22. At the start of time interval 81T1 (i.e., time=0), the energy storage unit 22 has no stored energy. During the time interval 81T1, the load switch 24 is switched OFF. During the time interval 81T1, Ipv−Ibuf>0 and therefore V(N1) increases with time from 0 to V1A. Since the ambient illumination is constant, the value Ipv−Iload is constant and equal to Ipv−Ibuff. At the very start of time period 81T2, V(N1)=V1A, therefore voltage detector 23 turns on the load switch 24 (SIG1=ACTIVE) enabling the application load 25 to consume energy from the photovoltaic unit 21 and/or the energy storage unit 22. Consequently, during the time period 81T2, the application load 25 firstly performs a boot-up sequence (boot-up sequence occurs when Ipv−Iload=Ipv−Ibuf−Iapp_bootup) and secondly performs at least 1 activity sequence (activity sequence occurs when Ipv−Iload=Ipv−Ibuf−Iapp). As shown in time period 81T2, the power consumption of the boot-up sequence is, in general, greater than the power consumption of the activity sequence. Thus, the time period 81T2 shows V(N2) decreasing with respect to time more quickly during the boot-up sequence than the activity sequence. The linear variations of V(N1) and V(N2) with respect to time is for illustrative purposes only and may not reflect the complexity of the power consumption. The values of Ipv−Ibuf−Iapp_bootup and Ipv−Ibuf−Iapp are negative during time period 81T2 because the energy consumed by the electronic device 60 is greater than the energy generated by the electronic device 60. While the value of Ipv−Iload is equal to Ipv−Ibuf−Iapp, at least 1 activity sequence is performed. At the start of time period 81T3, the value of V(N2) not greater than V2B but is greater than V1B, consequently the application load 25 enters the idle mode. During the idle mode, the value of Ipv−Iload is positive and equal to Ipv−Ibuf−Iapp_idle, therefore the energy consumed by the electronic device 60 is less than the energy generated by the electronic device 60 and so the value of V(N2) increases with respect to time. At the start of time period 81T4, V(N2)=V2A and therefore the application load 24 performs at least 1 activity sequence. Time period 81T4 differs from time period 81T2 because a boot-up sequence is not required when transitioning from the idle mode to the activity sequence. Since a boot-up sequence is not performed during 81T4, the second example electronic device 60 may have a higher circuit efficiency than the first example electronic device 20 for some ambient illumination conditions. Time period 81T5 shows identical operation to the previously described time period 81T3.

The duty cycle (D.C.) of SIG2 signal corresponds to the percentage of time the activity sequence is performed. The second example electronic device 60 automatically adapts to the current supplied by the photovoltaic unit 21, and therefore to the ambient lighting conditions, so that the repetition rate of the activity signal is optimized (i.e., the circuit efficiency is optimized). It can be shown that on average, the whole current consumption of an example electronic device disclosed herein will be equilibrated with the current generated by the photovoltaic unit 21 such that Ipv=Ibuf+D.C.×Iapp+(1−D.C.)×Iapp_idle.

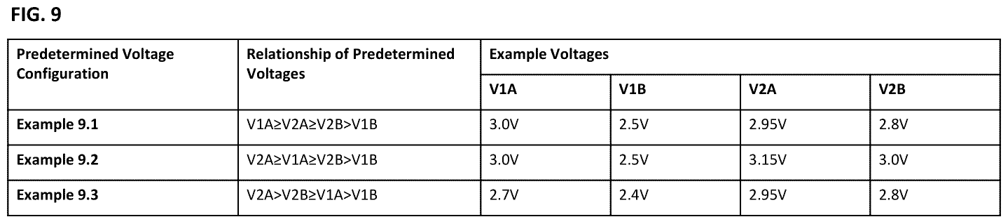

FIG. 9 is a table showing 3 predetermined voltage configurations (Example 9.1through 9.3) showing the relative relationship of the predetermined voltages V1A, V1B, V2A and V2B and example voltages for V1A, V1B, V2A and V2B. In general, the example configurations in FIG. 9 optimize the power delivery and hence the useful work performed by the harvested energy for a given level of ambient illumination. In general, the example configurations in FIG. 9 optimize the circuit efficiency for a given level of ambient illumination. For electronic device 60 and all subsequent tags disclosed herein, the following general design rules were found to contribute to optimizing both power delivery and circuit efficiency: V1A>V1B, V2A>V1B, V2B>V1B and V2A≥V2B. With reference to FIG. 1 and FIG. 9, experiments revealed that Example 9.1 enabled the best circuit efficiency for high ambient lux values (i.e., the third range of ambient lux values, LxR3). With reference to FIG. 1 and FIG. 9, experiments revealed that Example 9.2 enabled the best circuit efficiency for medium ambient lux values (i.e., the second range of ambient Lux values, LxR2). With reference to FIG. 1 and FIG. 9, experiments revealed that Example 9.3 enabled the best circuit efficiency for low ambient lux values (i.e., the first range of ambient Lux values, LxR1). For low cost operation, it is preferable to predetermine constant values for V1A, V1B, V2A and V2B.

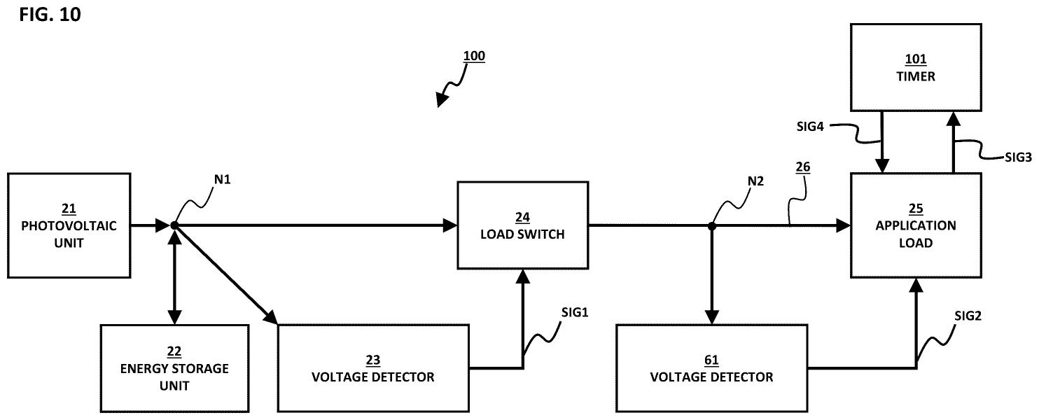

FIG. 10 is a block diagram of a third example electronic device 100. The third example electronic device 100 may be identical to the second example electronic device 60 except that the third example electronic device 100 has a timer 101. The timer 101 and the application load 25 are connected by SIG3 (signal 3) and SIG4 (signal 4). FIG. 10 shows the timer 101 external to the application load 25. If the timer 101 is an external to the application load, the application load 25 may provide power to the timer 101 via SIG3 and/or SIG4. Alternativity, the timer 101 can be an internal peripheral, for example, a Real Time Clock (RTC) timer, that is an integral part of the control unit which in turn is part of the application load 25. The application load 25 is configured to send a signal (SIG3) to the timer in order to start or restart a countdown sequence on the timer during the boot-up sequence. The application load 25 is also configured to send a signal (SIG3) to the timer in order to start or restart the countdown sequence on the timer during the activity sequence. The duration of the countdown time may be predetermined and may be 60 s and preferably 30 s. If the countdown on the timer 101 finishes, the timer 101 is configured to send a signal (SIG4) to the application load 25 in order to activate (i.e., perform) at least one activity sequence.

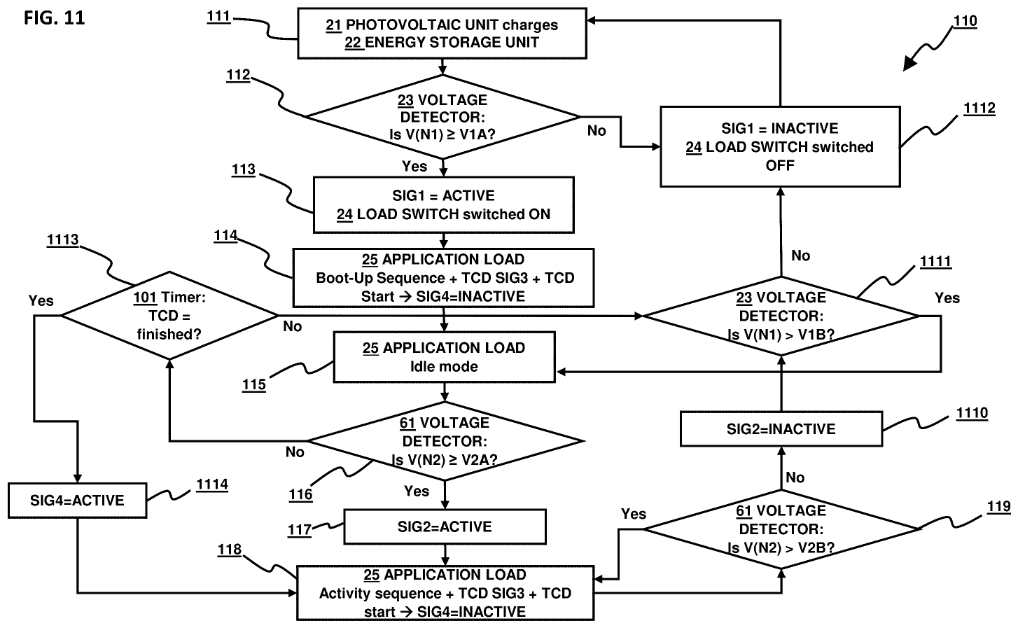

FIG. 11 is a flow diagram 110 illustrating the operation of the third example electronic device 100 shown in FIG. 10. Flow diagram item 111 shows the photovoltaic unit 21 producing electrical charge that is stored in the energy storage unit 22 (i.e., energy generated by the photovoltaic unit 21 is stored in the energy storage unit 22). Flow diagram item 112 shows the voltage detector 23 measuring the voltage at node 1. The voltage at node 1 is given by V(N1). If V(N1)>V1A then the voltage detector 23 sends a signal (SIG1=ACTIVE) to the load switch 24 which turns the load switch ON as shown in flow diagram item 113. The first predetermined voltage V1A may be in the range from VMP+20% and preferably in the range from VMP+10% where VMP is the voltage at the maximum power point of the photovoltaic unit 21. If V(N1) [symbol] V1A (i.e., V(N1)<V1A) then the voltage detector 23 sends a deactivate signal (SIG1=INACTIVE) to the load switch 24 which turns the load switch 24 OFF as shown in flow diagram item 112 and 1112. If the load switch 24 remains in the OFF state, the photovoltaic unit 21 continues to produce electrical charge that is stored in the energy storage unit 22. While the load switch 24 remains in the ON state, the application load 25 receives sufficient energy from the energy storage unit 22 and/or the photovoltaic unit 21 to perform a boot-up sequence, as shown by flow diagram item 114. The application load 25 sends a signal (SIG3) to the timer 101 so that the timer countdown sequence starts (TCD SIG3+TCD Start) as shown by flow diagram item 114. During flow diagram item 114, SIG4 is set to INACTIVE. The boot-up sequence may involve loading a program into volatile memory within a control unit (not shown in FIG. 10). The boot-up sequence may involve a clock stabilization process. Flow diagram item 115 shows the application load 25 entering an idle mode. Moving from the idle mode to an activity sequence does not require a further boot-up sequence. Flow diagram item 116 shows the voltage detector 61 measuring the voltage at node 2. The voltage at node 2 is given by V(N2). If V(N2)≥V2A then the voltage detector 61 sends a signal (SIG2=ACTIVE) to the application load 25 so that the application load 25 performs a predetermined activity sequence, as shown by flow diagram items 117 and 118 respectively. The predetermined activity sequence shown by flow diagram item 118 may include any of the example activity sequences shown in FIG. 4. The predetermined activity sequence shown by flow diagram item 118 may include transmitting information via a wireless communication unit to at least one further device (not shown). If the activity sequence includes transmitting information via a Bluetooth Low Energy unit, then a separate timer sequence (not shown) may be configured within the activity sequence to ensure a Bluetooth protocol related to transmission repetition rate is not violated. If V(N2)≯V2A, and, the timer 101 has not finished the countdown sequence, and, V(N1)>V1B, then the application load 25 remains in the idle mode, as illustrated by the loop in flow diagram 110 by the flow diagram items 115, 116, 1111 and 1113. However, if V(N2)≯V2A, and, the timer 101 has finished the countdown sequence (TCD=Finished?=YES), then the timer 101 sends a signal (SIG4=ACTIVE) to the application load, as shown by flow diagram items 116, 1113 and 1114. Every time the application load 25 has performed the activity sequence, the application load 25 sends a signal (SIG3) to the timer 101 so that the timer countdown sequence restarts (TCD SIG3+TCD Start) and SIG4 is set to INACTIVE, as shown by flow diagram item 118. After the application load 25 has performed the activity sequence shown by flow diagram item 118 then the activity sequence is performed again by the application load 25 if V(N2)>V2B as shown by the flow diagram item 119. If V(N2)≯V2B then voltage detector 61 sends a signal to the application load 24 (SIG2=INACTIVE) so that the application load stops performing further activity sequences as shown by the flow diagram item 1110. If V(N1)>V1B as shown in flow diagram item 1111 then the application load 24 enters the idle mode as shown by flow diagram item 115. If V(N1)≯V1B as shown in flow diagram item 1111 then voltage detector 23 sends a signal to turn off the load switch 24 (SIG1=INACTIVE) as shown in flow diagram item 1112. When load switch 24 is turned off, the photovoltaic unit 21 produces electrical charge that is stored in the energy storage unit 22 as shown by flow diagram item 111. Flow diagram item 1112 may be considered the start of the flow diagram 110.

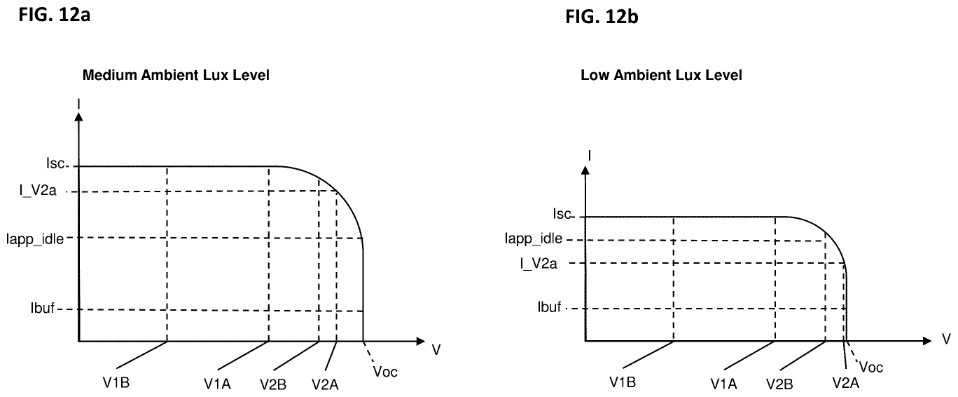

FIG. 12a shows a plot of current against voltage that is typical for electronic device 60 or electronic device 100 when the ambient lux is at a medium value, for example, LxR2. In FIG. 12a, the ambient lux is sufficiently high that the timer 101 countdown pertaining to electronic device 100 does not finish (i.e., the countdown is always restarted at the end of the activity sequence before the countdown has finished). FIG. 12b shows a plot of current against voltage that is typical for electronic device 60 or electronic device 100 when the ambient lux is a low value, for example, LxR1. In FIG. 12b, ambient lux is low enough for the timer 101 countdown pertaining to electronic device 100 to finish, thus the timer 101 actives the start of an activity sequence (SIG4=ACTIVE). With reference to FIGS. 12a and 12b, Isc is the current drawn in a short circuit, I_V2a is the current drawn for a voltage level of V2a and Voc is the voltage produced in an open circuit. The other terms (Iapp_idle, Ibuf, V1A, V1B, V2A and V2B) have been previously defined. With reference to FIG. 12b, the following 2 conditions are demonstrated:
Condition 1: When the voltage is equal to V2A, the current drawn is I_V2a. I_V2a is less than Iapp_idle.
Condition 2: When the voltage is equal to V1B, the current drawn is approximately equal to Isc. Isc is greater than Iapp_idle.

With reference to example electronic device 60 in FIG. 7, when condition 1 and condition 2 are both satisfied then the application load 25 remains in the idle mode forever (assuming the ambient lighting conditions do not change). With reference to example electronic device 100 in FIG. 11, when condition 1 and condition 2 are both satisfied then the timer 101 is able to finish the countdown so that timer 101 sends a signal (SIG4=ACTIVE) to the application load 25 so that the application load 25 performs an activity sequence. Consequently, the advantage of the third example electronic device 100 over the second example electronic device 60 is that for a range of low ambient illumination conditions, electronic device 100 can perform an activity sequence whereas electronic device 60 can't perform an activity sequence. In other words, when the timer 101 is configured as described previously, the resulting electronic device 100 does not get trapped in the idle mode for a given range of ambient lux values. The implementation of the timer 101 as previously described enables electronic device 100 to have a higher circuit efficiency than electronic device 60 for a range of low ambient illumination conditions.

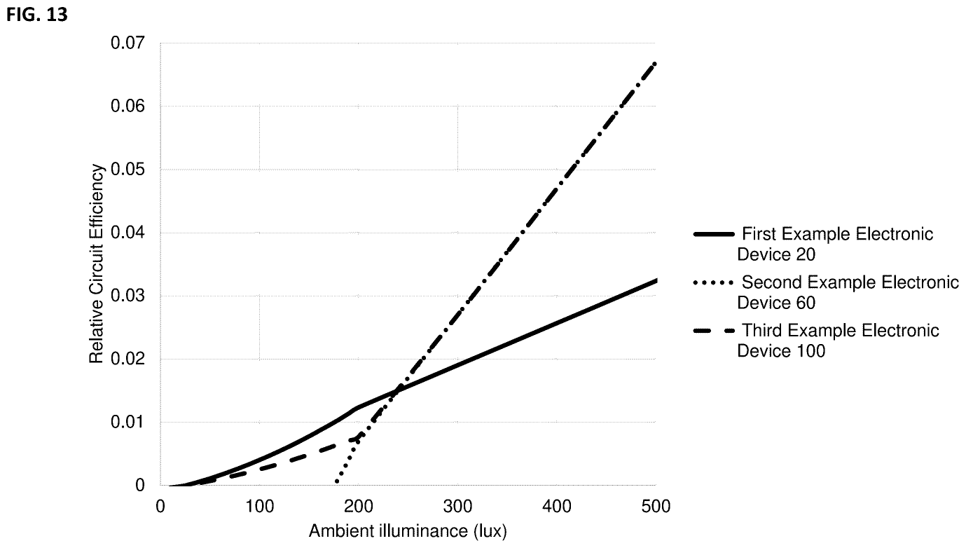

FIG. 13 shows a plot of relative circuit efficiency against ambient illuminance for the first example electronic device 20, the second example electronic device 60 and the third example electronic device 100. The first example electronic device 20 has the best circuit efficiency for low ambient lux levels (i.e., below ˜200 lux and in the range LxR1). The second example electronic device 60 and the third example electronic device 100 have equal best circuit efficiencies for medium ambient lux levels (i.e., ˜200 lux to ˜500 lux and in the range LxR2). The third example electronic device 100 has better circuit efficiency than the second example electronic device 60 for low ambient lux levels (i.e., below ˜200 lux and in the range LxR1).

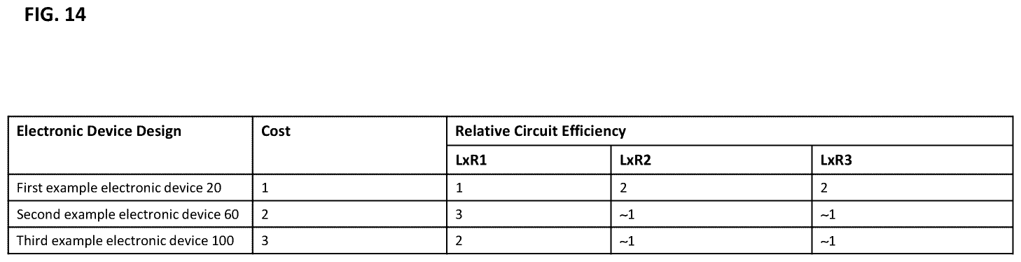

FIG. 14 shows a table that compares the relative merits of the first example electronic device 20, the second example electronic device 60 and the third example electronic device 100. A value of “1” in the table represents the best option. A value of “2” in the table represents the second-best option. A value of “3” in the table represents the third best option. The first example electronic device 20 is the cheapest electronic device and has the best circuit efficiency for medium ambient lux levels (i.e., below ˜200 lux and in the range LxR1). However, the first example electronic device 20 has the worst circuit efficiency for medium and high ambient lux levels (i.e., greater than ˜200 lux and in the ranges LxR2 and LxR3). The third example electronic device 100 is the most expensive electronic device but has a better circuit efficiency than the second example electronic device 60 for low ambient levels (i.e., less than ˜200 lux and in the range LxR1). The second example electronic device 60 and third example electronic device have similar circuit efficiencies for medium and high ambient lux levels (i.e., above ˜200 lux and in the ranges LxR2 and LxR3).

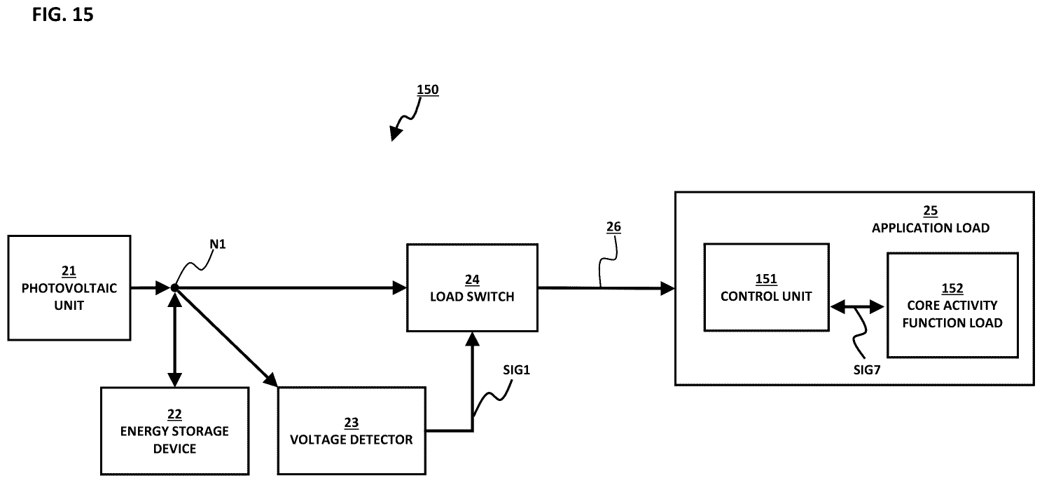

FIG. 15 is a block diagram of a further first example electronic device 150 with further detail added to the application load 25. The application load 25 includes a control unit 151 and a core activity function load 152. The control unit 151 is connected to the core activity function load 152 by SIG7. The control unit 151 may send signals to the core activity function load 152 via SIG7. The core activity function load 152 may send signals to the control unit 151 via SIG7. In reality, SIG7 may comprise multiple connections between the control unit 151 and the core activity function load 152 but only one connection is shown in FIG. 15 for purposes of brevity. The control unit 151 may include at least one field-programmable gate array (FPGA) and/or at least one microcontroller and/or at least one logic unit. The core activity function load 152 may include a wireless communication unit which may be a Bluetooth Low Energy wireless communication unit. The core activity function load 152 may include any of the example application loads shown in FIG. 4 (Example 4.1, Example 4.2, Example 4.3 and Example 4.4). The core activity function load 152 may include, or be associated with, at least 1 sensor and/or actuator as previously described. All sensors and actuators as previously described may be directly or indirectly connected to the control unit 151. The core activity function load 151 may include a passive load, such as an LED for example. The core activity function load 151 may include a low power display. In general, data collected by a sensor and/or actuator as previously described may be logged (i.e., stored in a memory) by the application load 25. More specifically, data collected by a sensor and/or actuator as previously described may be logged (i.e., stored in a memory) by the control unit 151 or the core activity function load 152. Data from a sensor and/or actuator that is logged may be transmitted to a further device (not shown) during the next activity sequence. Data from a sensor and/or actuator that is logged may be transmitted to a network of wireless receivers during the next activity sequence. Logging data from sensors/actuators and only transmitting said logged data in the next activity sequence may contribute to optimizing the power delivery, the circuit efficiency and the overall amount of useful work performed by the harvested energy of an electronic device disclosed herein. Alternativity, data collected by a sensor and/or actuator as previously described may be used immediately to initiate an activity sequence. However, there is no guarantee that there will be sufficient energy associated with an electronic device described herein to complete an activity sequence that was initiated by data collected by a sensor and/or actuator.

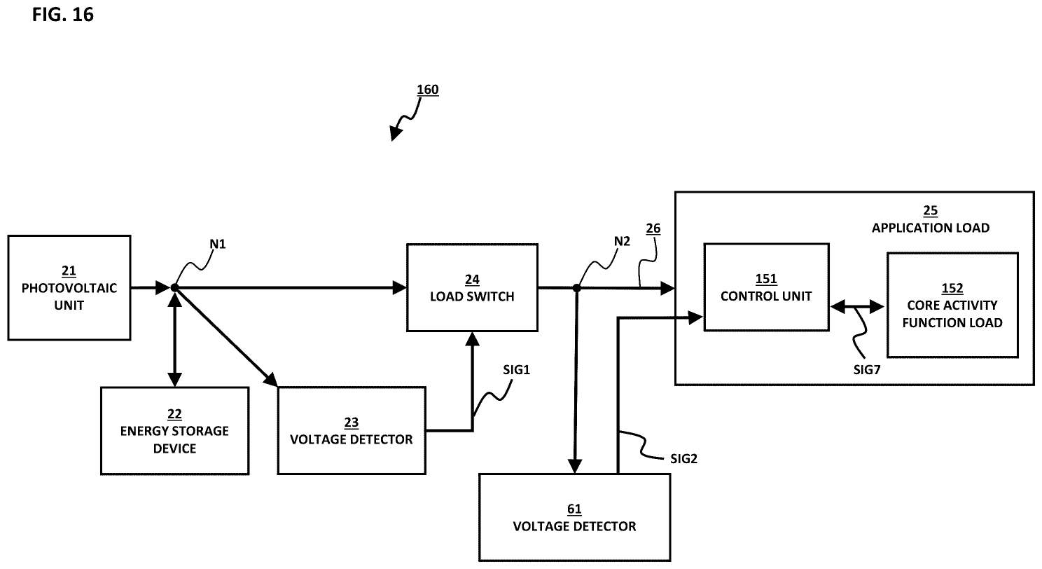

FIG. 16 is a block diagram of a further second example electronic device 160 with further detail added to the application load 25. The application load 25 includes a control unit 151 and a core activity function load 152, as previously described in FIG. 15. The voltage detector 61 is connected to the control unit 151 via SIG2.

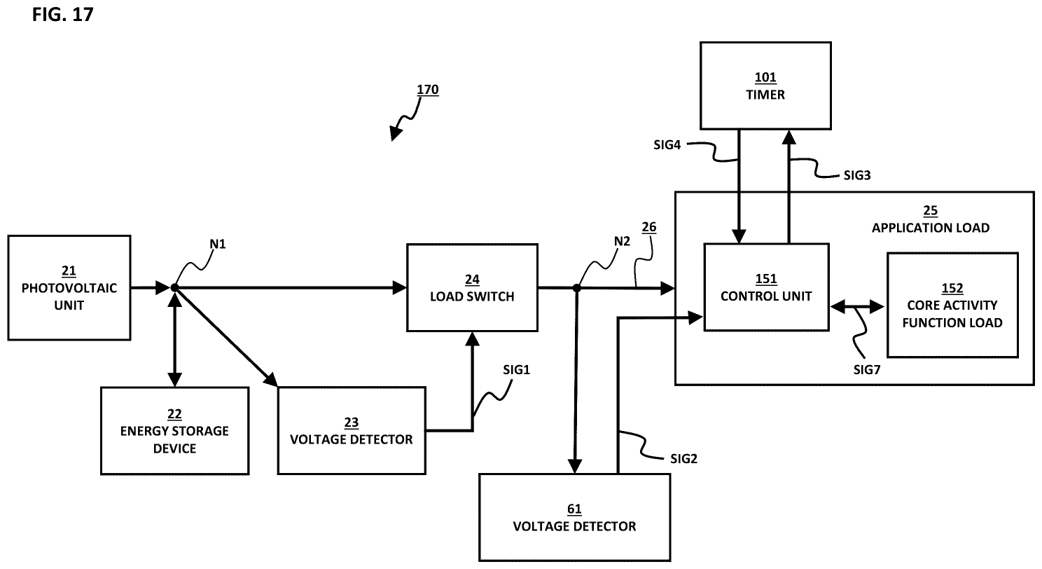

FIG. 17 is a block diagram of a further third example electronic device 170 with further detail added to the application load 25. The application load 25 includes a control unit 151 and a core activity function load 152 as previously described in FIG. 15. The voltage detector 61 is connected to the control unit 151 via SIG2. The timer 101 is connected to the application load 25, and specifically, connected to the control unit 151 via SIG3 and SIG4.

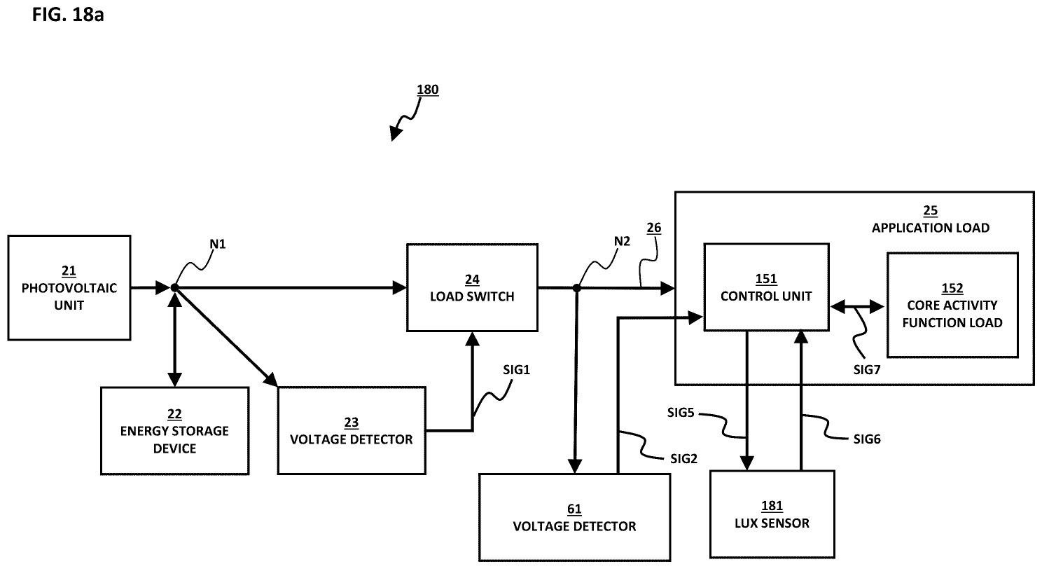

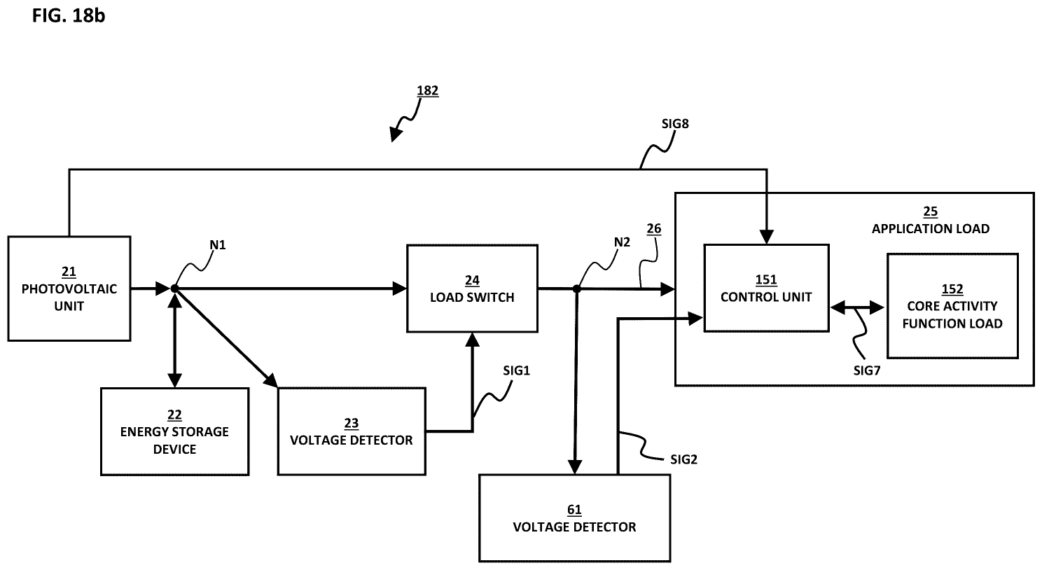

FIG. 18a is a block diagram of a fourth example electronic device 180 that is identical to the further second example electronic device 160 except that a lux sensor 181 is now connected to the application load 25, and specifically, connected to the control unit 151 via SIG5 and SIG6. The application load 25 may provide power to the lux sensor 181 via SIG5 and/or SIG6. When powered by the application load 25, the lux sensor 181 measures the lux of the ambient illumination and relays this measured lux information to the control unit 151 via SIG6. The lux sensor 181 therefore provides information to the control unit 151 related to level of illumination on the photovoltaic unit 21. Alternatively, but not shown, a lux sensor may be included within the core activity function load and be configured to perform the same function as the lux sensor 181 previously described. In general, FIG. 18a show a lux sensor that is associated with the application load 25.

FIG. 18b is a block diagram of a further fourth example electronic device 182 that is identical to the further second example electronic device 160 except that the photovoltaic unit 21 now has a further direct connection to the control unit 151 via SIG8. The photovoltaic unit 21 and the control unit 151 are configured so that the ambient lux is measured. Photovoltaic unit 21 in FIG. 18b performs an additional function that is similar to the function performed by the lux sensor 181 shown in FIG. 18a. The photovoltaic unit 21 therefore provides information to the control unit 151 related to level of illumination on the photovoltaic unit 21 itself.

With reference to FIGS. 18a and 18b, the control unit 151 may be configured so that it self-adapts operations within the application load 25 according to the ambient lux level. In general, the ambient lux level may be measured with any lux sensor associated with the application load. The ambient lux level may be measured with the lux sensor 181, as shown in FIG. 18a or a lux sensor (not shown) within the core activity function load 152. Alternatively, the ambient lux level may be determined by the control unit 151 which measures the current produced by the photovoltaic device 21 via SIG8, as shown in FIG. 18b. For a first predetermined ambient lux level, for example lux levels within LxR1, the control unit 151 operates the application load 25 in a similar manner to the first example electronic device 20. The control unit 151 may be configured so that for a second predetermined ambient lux level, for example lux levels within LxR2 and LxR3, the control unit operates the application load 25 in a similar manner to the second example electronic device 60. With reference to FIG. 13, the fourth example electronic device 180 and the further fourth electronic device 182 may be configured to operate with a circuit efficiency similar to the first example electronic device 20 for low ambient lux values and also operate with a circuit efficiency similar to the second example electronic device 60 for medium and high ambient lux values. The fourth example electronic device 180 and the further fourth example electronic device 182 may therefore be configured switch automatically (i.e., self-adapt) between a circuit efficiency similar to the first example electronic device 20 for low ambient lux values and a circuit efficiency similar to the second example electronic device 60 for medium and high ambient lux values in order to have the highest circuit efficiency for a given level of ambient illumination. In other words, the fourth example electronic device 180 and the further fourth example electronic device 182 may automatically optimize circuit efficiency for a given level of measured ambient illumination. The fourth example electronic device 180 and the further fourth electronic device 182 may have better circuit efficiency than the second example electronic device 60 for low ambient lux values. The fourth example electronic device 180 and the further fourth electronic device 182 may both have better circuit efficiency than the first example electronic device 20 for medium and high ambient lux values. In other words, the fourth example electronic device 180 and the further fourth electronic device 182 may both have a relatively high circuit efficiency for all levels of ambient illumination. The further fourth electronic device 182 may have a higher circuit efficiency than the fourth electronic device 180 for at least some levels of ambient illumination.

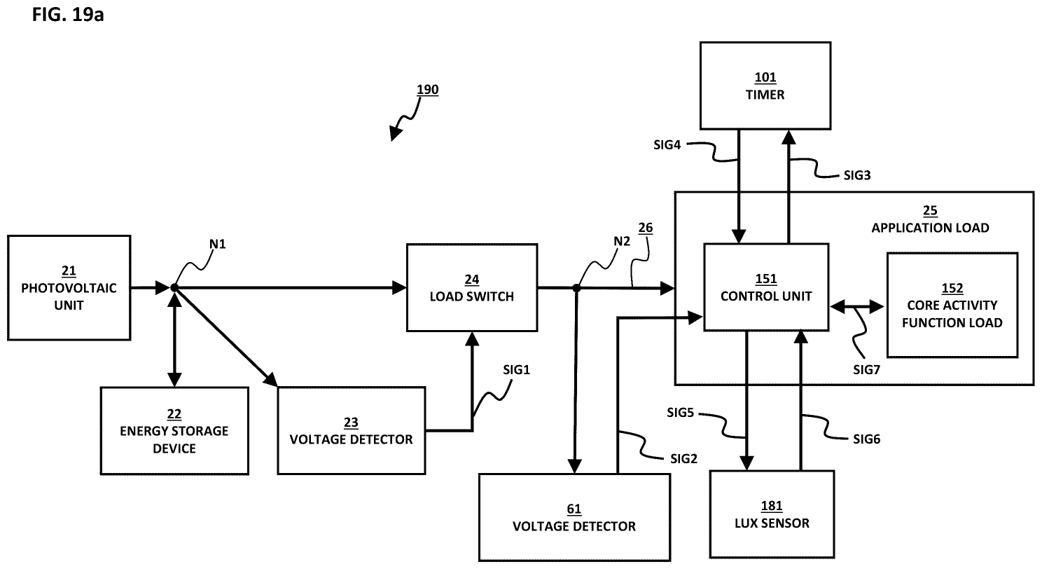

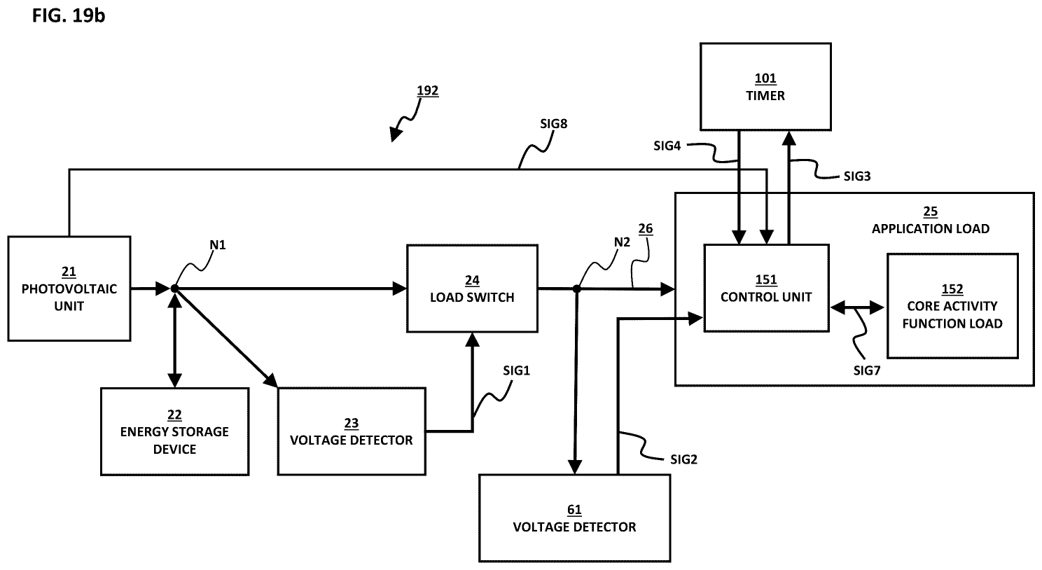

FIG. 19a is a block diagram of a fifth example electronic device 190 that is identical to the further third example electronic device 170 except that a lux sensor 181 is now connected to the application load 25, and specifically, connected to the control unit 151 via SIG5 and SIG6. The application load 25 may provide power to the lux sensor 181 via SIG5 and/or SIG6. When powered by the application load 25, the lux sensor 181 measures the lux of the ambient illumination and relays this measured lux information to the control unit 151 via SIG6. The lux sensor 181 therefore provides information related to level of illumination on the photovoltaic unit 21. Alternatively, but not shown, a lux sensor may be included within the core activity function load and be configured to perform the same function as the lux sensor 181 previously described. In general, FIG. 18a show a lux sensor that is associated with the application load 25.

FIG. 19b is a block diagram of a further fifth example electronic device 192 that is identical to the further third example electronic device 170 except that the photovoltaic unit 21 is now also connected to the control unit 151 via SIG8. In other words, in general, there is a direct connection from the photovoltaic unit 21 to the application load 25, and specifically, there is a direct connection from the photovoltaic unit 21 to the control unit 25. The photovoltaic unit 21 and the control unit 151 are configured so that the ambient lux is measured. Photovoltaic unit 21 in FIG. 19b performs an additional function that is similar to the function performed by the lux sensor 181 shown in FIG. 19a. In other words, the photovoltaic unit 21 can be considered to also operate as a lux sensor that is associated with the application load. The photovoltaic unit 21 therefore provides information to the control unit 151 related to level of illumination on the photovoltaic unit 21 itself.

With reference to FIGS. 19a and 19b, the control unit 151 may be configured so that it self-adapts operations within the application load 25 according to the ambient lux level. The ambient lux level may be measured with the lux sensor 181, as shown in FIG. 19a. Alternatively, the ambient lux level may be determined by the control unit 151 by measuring the current produced by the photovoltaic device 21, as shown in FIG. 19b. For a first predetermined ambient lux level, for example lux levels within LxR1, the control unit 151 operates the application load 25 in a similar manner to the first example electronic device 20. The control unit 151 may be configured so that for a second predetermined ambient lux level, for example lux levels within LxR2 and LxR3, the control unit operates the application load 25 in a similar manner to the third example electronic device 100. With reference to FIG. 13, the fifth example electronic device 190 and the further fifth example electronic device 192 may both be configured to operate with a circuit efficiency similar to the first example electronic device 20 for low ambient lux values and also operate with a circuit efficiency similar to the third example electronic device 100 for medium and high ambient lux values. The fifth example electronic device 190 and the further example fifth electronic device 192 may therefore be configured switch automatically (i.e., self-adapt) between a circuit efficiency similar to the first example electronic device 20 for low ambient lux values and a circuit efficiency similar to the second example electronic device 60 for medium and high ambient lux values in order to have the highest circuit efficiency for a given level of measured ambient illumination. In other words, the fifth example electronic device 190 and the further fifth example electronic device 192 may automatically optimize circuit efficiency for a given level of ambient illumination. The fifth example electronic device 190 and the further fifth example electronic device 192 may both have better circuit efficiency than the third example electronic device 100 for low lux values. The fifth example electronic device 190 and the further fifth example electronic device 192 may both have better circuit efficiency than the first example electronic device 20 for medium and high ambient lux values. In other words, the fifth example electronic device 180 and the further fifth example electronic device 192 may both have a relatively high circuit efficiency for all levels of ambient illumination. The further fifth electronic device 192 may have a higher circuit efficiency than the fifth electronic device 190 for at least some levels of ambient illumination.

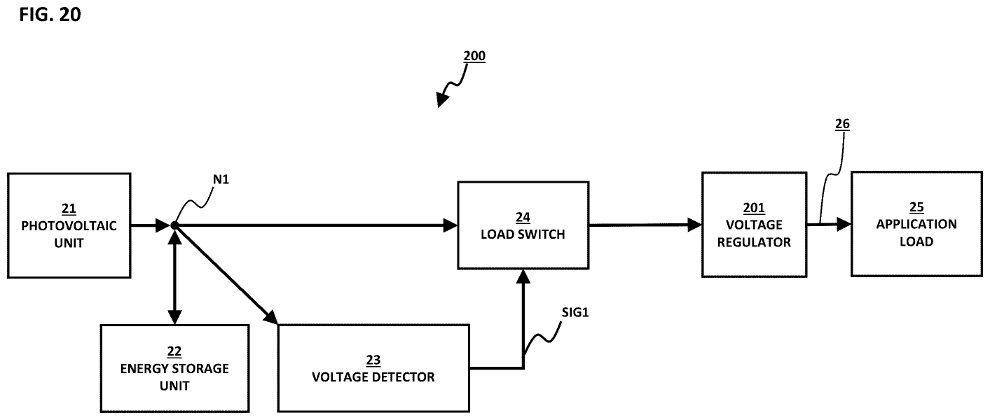

FIG. 20 is a block diagram of a sixth example electronic device 200. The sixth example electronic device 200 is identical to the first example electronic device 20 except that a voltage regulator 201 has been connected between the load switch 24 and the application load 25. In general, for all electronic device devices with one voltage detector described herein, a voltage regulator 201 may be connected between the load switch 24 and the application load 25. The voltage regulator 201 may be a low-dropout regulator (LDO) or a DC/DC converter. The voltage regulator 201 provides a stabilized environment for the operation of the electronic circuit. Therefore, the voltage regulator 201 may prevent undesirable events, such as false measurement of a sensor, misreading of a communication protocol value and brownout reset triggers (i.e., the voltage regulator 201 may prevent peripherals in the control unit 151 experiencing operational interrupts). The voltage regulator 201 may prevent voltage spikes; thus, the voltage regulator 201 may prevent an activity sequence stopping part way through a cycle. An advantage of including the voltage regulator 201 into an ultra-low power electronic device design is to enable a circuit design that may be more robust. The disadvantages of including the voltage regulator 201 into an ultra-low power electronic device design may include increased cost, increased circuit size (i.e., increased footprint) and increased power consumption, especially during the boot-up sequence. Increased power consumption may reduce circuit efficiency.

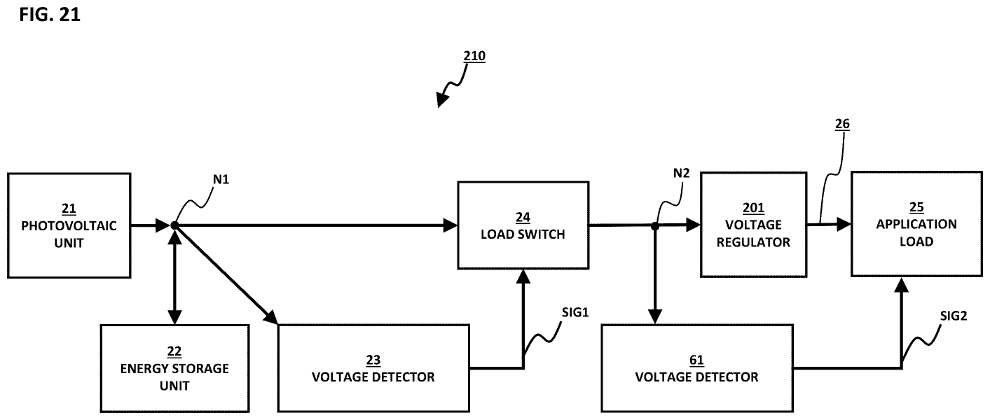

FIG. 21 is a block diagram of a seventh example electronic device 210. The seventh example electronic device 210 is identical to the second example electronic device 60 except that a voltage regulator 201 has been connected between node 2 (N2) and the application load 25. In general, for all electronic devices with two voltage detectors described herein, the voltage regulator 201 may be connected between the load switch 24 and the application load 25. The advantages and disadvantages of voltage regulator 201 have been discussed previously. A surprising result of experiments conducted by the inventors suggests that for clement environmental conditions (such as indoor use), electronic device operation for all embodiments disclosed herein may be sufficiently robust when voltage regulator 201 is omitted from the circuit design. In other words, the advantages of using an unregulated power supply (i.e., without voltage regulator) to the application load were found to outweigh the disadvantages.

The example electronic devices described herein have been configured to optimize power delivery to the application load associated with the electronic device so that the application load performs an optimized amount of useful work for the energy harvested by the electronic device. For an application load with a boot-up sequence and an activity sequence, the following operations may contribute to optimized power delivery:
1. The boot-up sequence is only performed if there is enough energy to complete the boot-up sequence and complete at least 1 activity sequence.
2. A further activity sequence is only performed if there is enough energy to complete said activity sequence.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. An electronic device comprising a photovoltaic unit, an energy storage unit, a voltage detector, a further voltage detector, a load switch and an application load, wherein the electronic device is configured to:
harvest and store energy from ambient illumination; and
optimize power delivery to the application load from at least one of the harvested energy and the stored energy,
wherein:
the photovoltaic unit, the energy storage unit, the voltage detector and an input of the load switch are connected to a common point;
the photovoltaic unit is configured to harvest energy from the ambient illumination;
an output of the load switch is coupled to the application load;
the voltage detector is configured to measure a voltage at the common point;
the voltage detector is further configured to turn on the load switch when a voltage measured at the common point has increased to a level that is greater than or equal to a first voltage in order to provide optimized power delivery to the application load from at least one of the energy storage unit and photovoltaic unit;
the voltage detector is further configured to turn off the load switch when a voltage measured at the common point has decreased to a level that is not greater than a second voltage in order that the photovoltaic unit stores energy in the energy storage unit;
the first voltage is greater than the second voltage;
the further voltage detector and an output of the load switch are connected at a further common point;
the further voltage detector is configured to measure a voltage at the further common point;
the further voltage detector and the application load are configured to perform an activity sequence when a voltage measured at the further common point has increased to a level that is greater than or equal to a third voltage;
the further voltage detector and the application load are further configured to stop performing further activity sequences when a voltage measured at the further common point has decreased to a level that is not greater than a fourth voltage;
the third voltage is greater than the second voltage;
the fourth voltage is greater than the second voltage; and
the third voltage is greater than the fourth voltage.

33. The electronic device of claim 32, configured:
so that the application load performs a boot-up sequence followed by at least one activity sequence when the load switch is turned on; and
to complete an activity sequence that has been started.

34. The electronic device of claim 32, wherein the first voltage is within 20% of the voltage produced by the photovoltaic unit at the maximum power point of the photovoltaic unit for a given temperature.

35. The electronic device of claim 32, wherein the energy storage unit comprises at least one of a battery and a rechargeable battery.

36. The electronic device of claim 32, wherein the energy storage unit comprises at least one of a capacitor and a supercapacitor.

37. The electronic device of claim 32, further comprising a voltage regulator connected between the load switch and the application load.

38. The electronic device of claim 32, further comprising at least one sensor associated with the application load and configured to collect data related to at least one of: orientation, acceleration, temperature, humidity, air pressure, light, lux, magnetic field, sound, infra-red radiation, ultra-violet radiation, gas, proximity, images, and a user input or any combination thereof.

39. The electronic device of claim 38, configured so that the sensor initiates an activity sequence.

40. The electronic device of claim 38, wherein the data collected by the sensor is stored in a memory associated with the application load.

41. The electronic device of claim 32, further comprising at least one actuator associated with the application load and configured to collect data related to at least one of: a push button, a switch, touch sensor and a user input or any combination thereof.

42. The electronic device of claim 41, configured so that the actuator initiates an activity sequence.

43. The electronic device of claim 41, wherein the data collected by the actuator is stored in a memory associated with the application load.

44. The electronic device of claim 32, further comprising a lux sensor associated with the application load, wherein:
the application load and the associated lux sensor are configured to measure an ambient lux level; and
the application load and the associated lux sensor are further configured to automatically optimize the average repetition rate of an activity sequence by adapting the average repetition rate according to the measured level of ambient lux such that on average the whole current consumption of the electronic device will be equilibrated with the current generated by the photovoltaic unit.

45. The electronic device of claim 32, wherein:
the photovoltaic unit has a direct connection to the application load;
the photovoltaic unit and application load are configured to measure an ambient lux level; and
the photovoltaic unit and application load are further configured to automatically optimize the average repetition rate of an activity sequence by adapting the average repetition rate according to the measured level of ambient lux such that on average the whole current consumption of the electronic device will be equilibrated with the current generated by the photovoltaic unit.

46. The electronic device of claim 32, further comprising a wireless communication unit and configured so that the application load performs a boot-up sequence followed by an activity sequence when the load switch is turned on, wherein the activity sequence includes transmitting information from the wireless communication unit to a network of wireless receivers.

47. The electronic device of claim 32, wherein:
the application load comprises a control unit connected to a core activity function load; and
the control unit and the core activity function load are configured to exchange information.

48. The electronic device of claim 47, wherein the control unit comprises at least one of: a field-programmable gate array (FPGA); a microcontroller; and a logic unit; or any combination thereof.

49. The electronic device of claim 32, further comprising a timer connected to the application load wherein the timer and the application load are configured to start a countdown sequence on the timer during a boot-up sequence or an activity sequence.

50. The electronic device of claim 49, wherein the timer and the application load are configured to perform at least one activity sequence when all the following conditions are satisfied:
the countdown sequence on the timer has finished;
the further voltage detector measures a voltage at the further common point that is less than the third voltage; and
the voltage detector measures a voltage at the common point that is greater than the second voltage.

51. A method performed by an electronic device to optimize power delivery to an application load, wherein the electronic device comprises: a photovoltaic unit, an energy storage unit, a voltage detector, a load switch and an application load, wherein the application load has a boot-up sequence and an activity sequence; the method comprising:
charging the energy storage unit from the photovoltaic unit while the load switch is turned off;
turning on the load switch in response to detecting a voltage on the voltage detector that is greater than or equal to a first voltage;
after turning on the load switch, performing the boot-up sequence; after the boot-up sequence, performing at least one activity sequence;
stopping performing activity sequences, and turning off the load switch, in response to detecting a voltage on the voltage detector that is not greater than a second voltage; and
the first voltage is greater than the second voltage.

52. The method of claim 51, wherein the electronic device comprises a further voltage detector, the method further comprising:
after the boot-up sequence, entering an idle mode in response to: i) detecting a voltage on the further voltage detector that is less than a third voltage and ii) detecting a voltage on the voltage detector that is greater than the second voltage;
exiting the idle mode and performing an activity sequence in response to detecting a voltage on the further voltage detector that is greater than or equal to the third voltage;
performing at least one further activity sequence in response to detecting a voltage on the further voltage detector that is greater than a fourth voltage;
stopping performing activity sequences, and entering the idle mode, in response to: i) detecting a voltage on the further voltage detector that is not greater than the fourth voltage and ii) detecting a voltage on the voltage detector that is greater than the second voltage; and
exiting the idle mode and turning off the load switch in response to detecting a voltage on the voltage detector that is not greater than the second voltage;
the third voltage is greater than the second voltage;
the fourth voltage is greater than the second voltage; and
the third voltage is greater than the fourth voltage.

53. The method of claim 51, wherein the electronic device comprises a further voltage detector and a timer, the method further comprising:
after performing the boot-up sequence, starting a countdown on the timer; after starting the countdown on the timer, entering an idle mode in response to:
i) detecting a voltage on the further voltage detector that is less than a third voltage, and ii) the countdown on the timer not having finished, and iii) detecting a voltage on the voltage detector that is greater than the second voltage;
exiting the idle mode and performing an activity sequence in response to either: i) detecting a voltage on the further voltage detector that is greater than or equal to the third voltage or ii) the countdown on the timer finishing;
during the activity sequence, re-starting the countdown on the timer;
performing at least one further activity sequence in response to detecting a voltage on the further voltage detector that is greater than a fourth voltage;
stopping performing the activity sequences, and entering the idle mode, in response to: i) detecting a voltage on the further voltage detector that is not greater than the fourth voltage and ii) detecting a voltage on the voltage detector that is greater than the second voltage; and
exiting the idle mode and turning off the load switch in response to detecting a voltage on the voltage detector that is not greater than the second voltage;
the third voltage is greater than the second voltage;
the fourth voltage is greater than the second voltage; and the third voltage is greater than the fourth voltage.
